(19) United States
(12) Patent Application Publication
(10) Pub. No.: US 2024/0183006 A1
(43) Pub. Date: Jun. 6, 2024

(54) IONIC LIQUID BASED PROCESSES FOR EXTRACTION OF METALS

(71) Applicant: WYONICS, LLC, Laramie, WY (US)

(72) Inventors: Kristin R. DI BONA, Laramie, WY (US); Caleb M. HILL, Laramie, WY (US); Gabriela GURAU, Tuscaloosa, AL (US); Robin D. ROGERS, Tuscaloosa, AL (US)

(21) Appl. No.: 18/283,747

(22) PCT Filed: Mar. 23, 2022
(86) PCT No.: PCT/US2022/021519

§ 371 Date: Sep. 22, 2023

Related U.S. Application Data
(60) Provisional application No. 63/164,775, filed on Mar. 23, 2021.

(51) Int. Cl. C22B 59/00; B01D 11/02; C01F 17/10; C22B 3/16; C22B 3/24; C22B 3/44; C22B 4/00; C22B 7/00; C22B 7/02

(52) U.S. Cl. CPC C22B 59/00; B01D 11/0211; B01D 11/028; B01D 11/0288; C01F 17/10; C22B 3/1666; C22B 3/24; C22B 3/44; C22B 4/00; C22B 7/006; C22B 7/02

(57) ABSTRACT

The present disclosure provides for a method of obtaining metals from a source, including contacting the source with an ionic liquid in the absence of acid, thereby extracting the metals from the source and providing an ionic liquid extraction composition; and recovering the metals from the ionic liquid extraction composition, wherein the source includes coal, coal by-products, ore, tar, or electronic waste. Further, the present disclosure provides for a carbon material made by a process that includes contacting a source with an ionic liquid in the absence of acid, thereby extracting metals from the source and providing an ionic liquid extraction composition; and recovering the metals from the ionic liquid extraction composition, wherein the source includes coal, coal by-products, ore, tar, or electronic waste, further wherein the carbon material includes solids, liquids, carbon films, carbon fibers, carbon nanomaterials, or any combination thereof.

### CROSS REFERENCE TO RELATED APPLICATIONS

This application claims the benefit of priority to U.S. provisional application 63/164,775, filed Mar. 23, 2021, which is incorporated by reference herein in its entirety.

### BACKGROUND

Rare earth metals or rare earth elements (REEs) are a relatively abundant group of seventeen elements found in the periodic table. Out of the seventeen, fifteen elements comprise the lanthanide series found between atomic number 57 and 71. In addition to lanthanides, scandium and yttrium are also considered to be REEs as they are found in the same ore as the other REEs and show similar chemical properties. REEs are highly important to the United States (U.S.) clean energy technologies, and in today's society can be found in high technology products like medical devices, catalysts, defense missiles, hybrid engines, cell phones, magnets, etc. REEs such as neodymium, praseodymium, and dysprosium are key components in many new “green” technologies and are among the “critical materials” for modern technologies. The need for REEs continues to rise, increasing their value and demand. The U.S. economy and national security is becoming increasingly dependent on a stable supply of REEs.

It is estimated that China currently controls an estimated 85-97% of the total REE market, thus allowing China to not only set the price of REEs, but also to limit or restrict access to REEs. Therefore, there is a need to develop safe, sustainable, and affordable REE extraction techniques for use in the Unites States.

REE-mining is an energy intensive, environmentally detrimental process, that typically does not recover the cost of mining in the sale of REEs. The development of extraction techniques capable of recovering large quantities of REEs from REE-containing sources, in an environmentally safe and economical manner, would support a shift away from foreign reliance for REEs.

Like REE, there are other metals in high demand that are difficult or costly to obtain. For example, some alkali metals, alkaline earth metals, and transition metals are in high demand. Lithium is one of the critical elements with widespread applications in next-generation technologies, including energy storage, electric mobility and cordless devices. Due to its unique applications, lithium cannot be substituted in most applications; therefore, a steady increase of 8-11% in annual demand is anticipated. Meeting such a rising demand for lithium requires prospecting and processing all viable resources.

What are thus needed are new methods and compositions for obtaining metals. The present invention addresses these and other needs.

### SUMMARY

In accordance with the purposes of the disclosed materials and methods, as embodied and broadly described herein, the disclosed subject matter, in one aspect, relates to ionic liquids and obtaining metal from a source.

Thus, in one aspect, the present disclosure provides for a method of obtaining metals from a source, including contacting the source with an ionic liquid in the absence of acid, thereby extracting the metals from the source and providing an ionic liquid extraction composition; and recovering the metals from the ionic liquid extraction composition, wherein the source includes coal, coal by-products, ore, tar, or electronic waste.

In a further aspect, the present disclosure provides for a carbon material made by a process that includes contacting a source with an ionic liquid in the absence of acid, thereby extracting metals from the source and providing an ionic liquid extraction composition; and recovering the metals from the ionic liquid extraction composition, wherein the source comprises coal, coal by-products, ore, tar, or electronic waste, further wherein the carbon material comprises solids, liquids, carbon films, carbon fibers, carbon nanomaterials, or any combination thereof.

The details of one or more embodiments of the disclosure are set forth in the accompanying drawings and the description below. Other features, objects, and advantages of the disclosure will be apparent from the description and drawings, and from the claims.

### DESCRIPTION OF THE FIGURES

The accompanying drawings, which are incorporated in and constitute a part of this specification, illustrate certain examples of the present disclosure and together with the description, serve to explain, without limitation, the principles of the disclosure. The application includes reference to the accompany figures, in which:

FIGS. 1A-1G show images of dissolution of coal into IL after 8 hrs. at T2 (100° C.), wherein the ionic liquid in 1A is IL #1, 1B is IL #2, 1C is IL #3, 1D is IL #4, 1E is IL #5, 1F is IL #6, and 1G is IL #7.

FIG. 2 shows a schematic of an exemplary process for extraction and recovery of REEs from coal.

FIG. 3 shows a P&ID drawing of an exemplary process for extraction and recovery of REEs.

FIGS. 4A-4F shows source/IL solution isolated via centrifugation. FIGS. 4A-C show dissolved Cordero Rojo Coal (CRC)/IL #1 solutions and FIGS. 4D-F show dissolved Fly Ash (FA)/IL #1 solutions.

FIGS. 5A-5F show residue isolated via centrifugation and washed to remove residual IL and the corresponding SEM images. FIG. 5A shows. 0.5 g of untreated coal, FIG. 5B shows CRC and IL #1 before treatment, FIG. 5C shows the separated residue after 2 minutes, and FIG. 5D shows the swollen residue after washings to remove IL. FIG. 5E shows and SEM image of starting CRC and FIG. 5F shows IL#1 treated CRC, for 2 minutes at T3.

FIGS. 6A-6H show carbonaceous materials extracted from CRC/IL #1 solutions after residue removal after centrifugation. FIG. 6A shows a coal-IL solution at T1 after 10 minutes, FIG. 6B shows a coal-IL solution at T1 after 24 hours, FIG. 6C shows a coal-IL solution at T2 after 24 hours, and FIG. 6D shows a coal-IL solution at T3 after 2 minutes. FIG. 6E shows an HO precipitate at T1 after 10 minutes, FIG. 6F shows an H₂O precipitate after 24 hours, FIG. 6G shows an H₂O precipitate after 24 hours, and FIG. 6H shows an H₂O precipitate at T3 after 2 minutes.

FIGS. 7A-7B show the acidification of an exemplary IL solution. FIG. 7A shows acidified CRC/IL #1 solution, with REEs in the aqueous acidic layer, and FIG. 7B shows the acidified CRC/IL #1 solution, with REEs in the aqueous acidic layer, after centrifugation.

FIG. 8 shows a graphic representation of the relationship between the % of REEs extracted from coal into IL and the wt. % of coal in the ionic liquid.

FIG. 9 shows sequential 2 minutes T3 IL #1 treatments of the same sample of CRC in order of left to right.

FIG. 10 shows an image of reduction in Nd signal (dark) after resin incubation (light) at the expected efficiency.

FIGS. 11A-11D shows images of IL-treated CRC residues. FIG. 11A shows images of swollen residue from initial 5% CRC/IL #1 treated for a first time at T3 for 2 minutes and for a second time again at T3 for 2 minutes. FIG. 11B shows swollen residue from initial 5% CRC/IL #1 treated at T3 for 2 minutes. FIG. 11C shows the treated swollen residue from initial 5% CRC/IL #1 with no grinding. FIG. 11D shows the treated swollen residue from initial 5% CRC/IL # 1 after grinding.

FIG. 12 shows an image of solid REE-product generated and a graph of PXRD data confirming the identities of the recovered REE-product.

FIGS. 13A-13C show exemplary hydroxides extracted from REE-OAc doped IL solutions. FIG. 13A shows Cerium hydroxide, FIG. 13B shows Neodymium (Nd) hydroxide, and FIG. 13C shows Yttrium hydroxide.

FIG. 14 shows Nd electroprecipitation from simulated resin eluent at various pHs.

FIGS. 15A-15C shows salts doped in aqueous simulated resin solution and electrodeposited. FIG. 15A shows Nd chloride salt, FIG. 15B shows Nd acetate salt, and FIG. 15C shows Y chloride salt.

### DETAILED DESCRIPTION

The following description of the disclosure is provided as an enabling teaching of the disclosure in its best, currently known embodiment(s). To this end, those skilled in the relevant art will recognize and appreciate that many changes can be made to the various embodiments of the invention described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Although specific terms are employed herein, they are used in a generic and descriptive sense only and not for purposes of limitation.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### General Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of ” Similarly, the term “consisting essentially of” is intended to include examples encompassed by the term “consisting of ”

As used in the specification and the appended claims, the singular forms “a,” “an” and “the” include plural referents unless the context clearly dictates otherwise. Thus, for example, reference to “a compound”, “a composition”, or “a disorder”, includes, but is not limited to, two or more such compounds, compositions, or disorders, and the like.

It should be noted that ratios, concentrations, amounts, and other numerical data can be expressed herein in a range format. It can be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it can be understood that the particular value forms a further aspect. For example, if the value “about 10” is disclosed, then “10” is also disclosed.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

### Methods

The present disclosure, in one aspect, provides for a method of obtaining metals from a source, including contacting the source with an ionic liquid in the absence of acid, thereby extracting the metals from the source and providing an ionic liquid extraction composition; and recovering the metals from the ionic liquid extraction composition, wherein the source includes coal, coal by-products, ore, tar, or electronic waste. In some embodiments, extraction of metals can be repeated so as to maximize the amount of metal extracted from the source. This can involve extracting metals from the resulting undissolved residue of each repetition. In doing so, the same ionic liquid can be used with each repetition, or one or more different ionic liquids can be used with each repetition. In some embodiments, the metals that are obtained can include alkali metals, e.g., Li, Na, K, Rb, Cs, and any combination thereof. In some embodiments, the metals that are obtained include alkaline metals, e.g., Be, Mg, Ca, Sr, Ba, Ra, and any combination thereof.

In some embodiments, the metals that can be obtained can include rare earth elements. As used herein, “rare earth element (REE)”, or “rare earth metal”, is used to refer to scandium, yttrium, and the fifteen elements found on the periodic table in the lanthanide series, found between atomic numbers 57-71. More specifically, this includes lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Th), yterrbium (Yb), lutetium (Lu), and the transition elements scandium (Sc) and yttrium (Y). Scandium and yttrium can be found in the same ore as elements in the lanthanide series and can show similar chemical properties to each other and the elements in the lanthanide series. REEs can be used in high-tech consumer products, such as cellular telephones, computer hard drives, electric and hybrid vehicles, and flat-screen monitors and televisions. Significant defense applications of REEs can include electronic displays, guidance systems, lasers, and radar and sonar systems.

### Source

Domestic REE sources that can be exploited to obtain metals like alkali, alkaline earth, and rare earth elements and reduce waste include coal and coal by-products, high-REE ores (e.g., carbonatite), and electronic waste. Coal and coal by-products (e.g., ash) are cheap and abundant resources known to contain REEs at low concentrations, with an estimated 6 million metric tons of REE content in the Western state coal basins, including the Powder River Basin (PRB) in WY. PRB coal, for example, often contains approximately 550 ppm of REEs, while fly ash contains approximately 350 ppm. Though the concentration of REEs in coal is low, total amount is high due to coal's overall abundance.

In addition to REEs, coal, coal by-products, ore, mine tailings, industrial waste, municipal waste, and electronic waste can contain a number of various co-products including other metals (e.g., Li, V), chemicals, and carbon, which can be extracted and converted into advanced carbon materials. Recovery of co-products, such as carbon materials, chemicals, and other metals is an important part of the process described, reducing the waste generated and increasing the overall value of the process.

As used herein, “source” refers to sources that contain metals such as REEs, which can include, but is not limited to, coal, coal by-products, high-REE ores and deposits, minerals, mine tailings, industrial waste, municipal waste, and electronic waste. Minerals that can include REEs include, but are not limited to, carbonates, fluorocarbonates, hydroxylcarbonates, oxides, silicates, and phosphates. Deposits can be found in carbonatite, peralkaline igneous systems, magmatic magnetite-hematite bodies, iron oxide-copper-gold deposits, xenotime-monazite accumulations in mafic gneiss, ion-absorption clay deposits, and monazite-xenotime-bearing placer deposits. High-REE ores can include, but are not limited to, monazite, bastnaesite, xenotime, ilmenite, rutile, and zircon. Electric waste can include, but is not limited to, mobile phones, laptops, or electric vehicle batteries.

In some examples, coal can be black or brownish-black and can have a composition that (including inherent moisture) consists of more than 50 percent by weight and more than 70 percent by volume of carbonaceous material. Coal can form from plant remains that have been compacted, hardened, chemically altered, and metamorphosed by heat and pressure over geologic time. The precursor to coal is peat. Peat is a soft, organic material consisting of partly decayed plant and mineral matter. When peat is placed under high pressure and heat, it undergoes physical and chemical changes, also known as coalification, to become coal. Coal can be found all over the world, including the United States, predominantly in places where prehistoric forests and marshes existed before being buried and compressed over millions of years. Some of the largest coal deposits are located in the Appalachian basin in the eastern U.S., the Illinois basin in the mid-continent region, and throughout numerous basins and coal fields in the western U.S. and Alaska.

There are four types of coal: anthracite, bituminous, subbituminous, and lignite. Anthracite coal is the highest rank of coal and is hard, brittle and black lustrous coal. It can contain a high percentage of fixed carbon, from 86% to 97%, and a low percentage of volatile matter. Bituminous coal can have a high heating (Btu) value and is used in electricity generation and steel making in the United States. Bituminous coal can be blocky and have thin, alternating, shiny and dull layers. Bituminous coal can contain from 45% to 86% fixed carbon. Subbituminous coal can be black in color and primarily dull, with a carbon content from 35% to 45% fixed carbon. It has low-to-moderate heating values and is often used in electricity generation. Lignite coal is the lowest grade coal with the least concentration of carbon, from 25% to 35%. Lignite can have a low heating value and a high moisture content and is often used in electricity generation.

Coal by-products refers to the waste produced from coal combustion. Coal by-products include, but are not limited to, scrubber sludge, synthetic gypsum, fly ash, bottom ash, and boiler slag. Scrubber sludge is the waste, wet or dry, produced from flue-gas desulfurization. Scrubber sludge can be used to make synthetic gypsum. Boiler slag is produced in coal-fired power plants that use wet-bottom boilers. It forms from melted minerals left over from coal combustion. As used herein, “fly ash” refers to the fine-grained, powdery particulate that is carried off in flue gas during coal combustion. As used herein, “bottom ash” refers to the coarse, granular, incombustible by-product of coal combustion that is collected from the bottom of coal burning devices, such as furnaces, power plants, boilers, furnaces, or incinerators.

Ore refers to naturally occurring materials, such as minerals or rocks, from which substances, such as metals, can be processed, extracted, mined, treated, or any combination thereof. Types of ore include magmatic, or volcanic, ore, carbonate alkaline ore, metamorphic ore, and sedimentary ore. Magmatic ore can include, but is not limited to, nickel, copper, and iron. Carbonate alkaline ore can include, but is not limited to, rare earth elements, such as diamonds. Metamorphic ore can include, but is not limited to, lead, zinc, silver, and some iron oxides. Sedimentary ore can include, but is not limited to, gold, platinum, zinc, and tin. Ore can include, but is not limited to, magnesite, bauxite, sphalerite, hematite, zincite, magnetite, magnetite, cuprite, or any combination thereof. Ore can include carbonatite, wherein “carbonatite” refers to a type of igneous rock defined by a mineralogic composition of greater than 50% carbonate minerals. Carbonatite is an ore and can include calcite and dolomite. Carbonatite can also include bastnaesite, parasite, monazite, pyrochlore, or any combination thereof.

Tar refers to a dark brown or black viscous liquid of hydrocarbons and free carbon, obtained from a wide variety of organic materials through destructive distillation. In one example, tar can be produced from coal.

Electronic waste refers to electrical or electronic devices that are discarded. Examples of electronic waste include TVs, phones, computer monitors, printers, scanners, keyboards, mics, cables, circuit boards, lamps, clocks, flashlights, calculators, phones, answering machines, digital/video cameras, radios, VCRs, DVD players, MP3 players, or CD players. This can include used electronics that are destined for refurbishment, reuse, resale, salvage recycling through material recovery, or disposal.

In other examples the source can be mine tailings, non-cellulosic industrial waste, or municipal waste.

In some embodiments, the source can further include a biopolymer. As used herein, “biopolymers” are polymers synthesized by living organisms. Biopolymers can be polynucleotides, such as DNA or RNS, polypeptides, or polysaccharides. Biopolymers can also include, but are not limited to, cellulose and chitin. As used herein, “cellulose” refers to a polysaccharide consisting of 3000 or more glucose monomers. Cellulose is a structural component of the primary cell wall of green plants and forms of algae and oomycetes. Four types of cellulose include cellulose I, II, III, IV. As used herein, “chitin” refers to a long-chain polymer of N-acetylglucosamine, an amide derivative of glucose. Chitin is a component of cell walls in fungi and exoskeletons of arthropods. Three forms of chitin can include α, β, and γ chitin.

In some embodiments, the source can be dried. Drying a sample can include using an oven, and more specifically, drying a sample in an oven overnight, at approximately 100° C., to remove the water content.

In some embodiments, the source can be ground to a particle size of less than 250 μm. Further, the source can be ground to a particles size of less than 200 μm, 175 μm, or 150 μm. Additionally, the source can be ground from a particle size from 125 μm to 250 μm, 150 μm to 250 μm, 175 μm to 250 μm, or 200 μm to 250 μm.

In some embodiments, the source can be ground to a particle size of less than 125 μm. Further, the source can be ground to a particle size of less than 100 μm, 75 μm, or 50 μm. Additionally, the source can be ground from a particle size from 45 μm to 125 μm, 50 μm to 125 μm, 75 μm to 125 μm, or 100 μm to 125 μm.

In some embodiments, the source can be ground to a particle size of less than 45 μm. Further, the source can be ground to a particle size of less than 40 μm, 30 μm, 20 μm, 10 μm, or 5 μm. Additionally, the source can be ground to a particle size from 5 μm to 45 μm, 10 μm to 45 μm, 20 μm to 45 μm, 30 μm to 45 μm, or 40 μm to 45 μm.

In some embodiments, the source can be sieved. A sample can be sieved to a particle size of, for example, less than 45 μm with a 45 μm sieve, less than 125 μm with a 125 μm sieve, or less than 250 μm with a μm sieve. Examples of sieves include electroformed sieves, perforated plate sieves, sonic sifter sieves, air jet sieves, or wet wash sieves.

### Ionic Liquids

As used herein, an ionic liquid (IL) is a low melting salt, usually melting below 150° C., which can exhibit low or no vapor pressure (nonvolatile), high thermal stability (nonflammable), and high electrochemical stability. In some embodiments, ILs are versatile as the cation and anion of an IL can be tuned independently of each other to adjust the physicochemical properties of the compound. In further embodiments, ILs are in a liquid state. In certain preferred embodiments, ionic liquids may include cations that include, but are not limited to, 1-ethyl-3-methyl-(EMIM), 1-butyl-3-methyl-(BMIM), 1-octyl-3 methyl (OMIM), 1-decyl-3-methyl-(DMIM), 1-dodecyl-3-methyl-docecylMIM), 1-butyl-2,3-dimethylimidazolium (DBMIM), 1,3-di(N,N-dimethylaminoethyl)-2-methylimidazolium (DAMI), and 1-butyl-2,3-dimethylimidazolium (BMMIM), 4-methyl-N-butyl-pyridinium (MBPy) and N-octylpyridinium (C8Py), tetraethylammonium (TEA), tetrabutylammonium (TBA), or any combination thereof. In further embodiments, ionic liquids may include anions that include, but are not limited to, tetrafluoroborate (BF4), hexafluorophosphate (PF₆), bis-trifluoromethanesulfonimide (NTf₂), trifluoromethanesulfonate (OTf), dicyanamide (N(CN)₂), hydrogen sulphate (HSO₄), ethyl sulphate (EtOSO₃), or any combination thereof.

In some examples, a cation of an ionic liquid suitable for use herein can be cyclic and correspond in structure to a formula shown below:

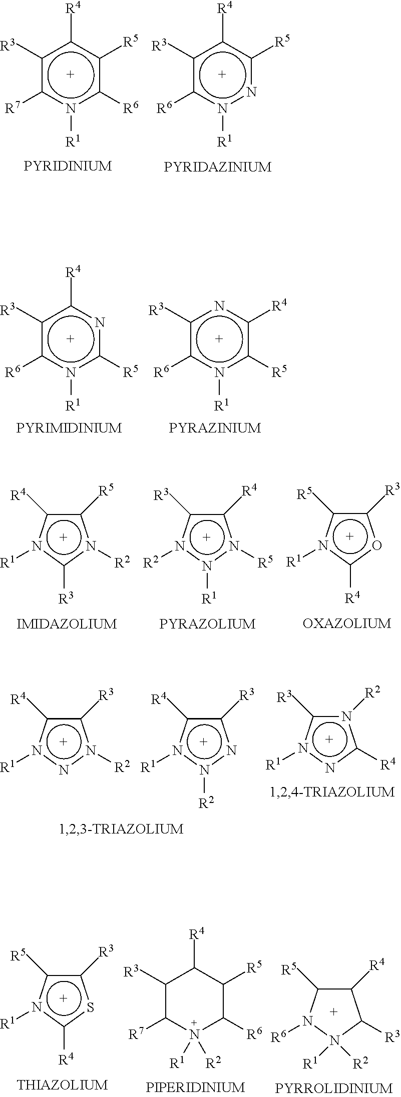

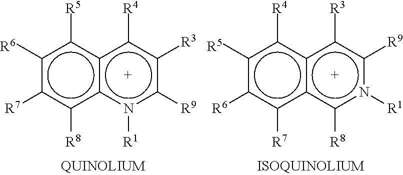

wherein R¹ and R² are independently a C₁-C₆ alkyl group or a C₁-C₆ alkoxyalkyl group, and R³, R⁴, R⁵, R⁶, R⁷, R⁸, and R⁹ (R³-R⁹), when present, are independently H, a C₁-C₆ alkyl, a C₁-C₆ alkoxyalkyl group, or a C₁-C₆ alkoxy group. In other examples, both R¹ and R² groups are C₁-C₄ alkyl, with one being methyl, and R³-R⁹, when present, are H. Exemplary C₁-C₆ alkyl groups and C₁-C₄ alkyl groups include methyl, ethyl, propyl, iso-propyl, butyl, sec-butyl, iso-butyl, pentyl, iso-pentyl, hexyl, 2-ethylbutyl, 2-methylpentyl, and the like. Corresponding C₁-C₆ alkoxy groups contain the above C₁-C₆ alkyl group bonded to an oxygen atom that is also bonded to the cation ring. An alkoxyalkyl group contains an ether group bonded to an alkyl group, and here contains a total of up to six carbon atoms. It is to be noted that there are two iosmeric 1,2,3-triazoles. In some examples, all R groups not required for cation formation can be H.

In one example, all R groups that are not required for cation formation; i.e., those other than R¹ and R² for compounds other than the imidazolium, pyrazolium, and triazolium cations shown above, are H. Thus, the cations shown above can have a structure that corresponds to a structure shown below, wherein R¹ and R² are as described before.

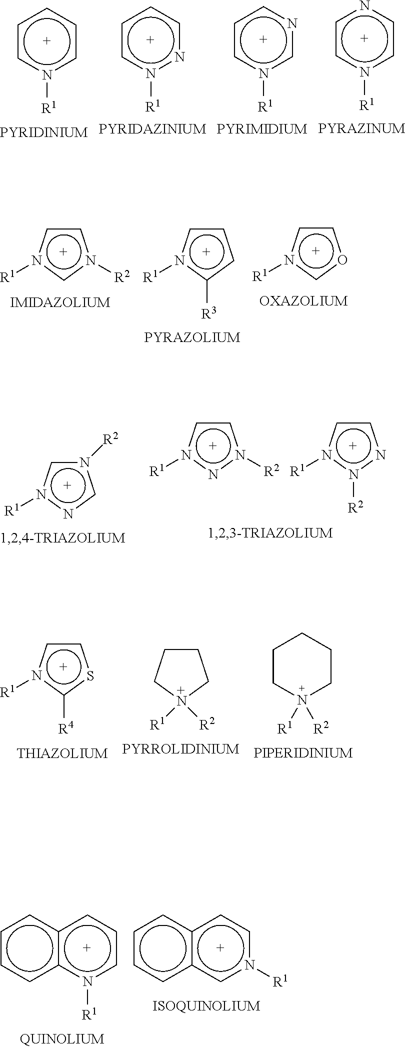

A cation that contains a single five-membered ring that is free of fusion to other ring structures is suitable for use herein. Exemplary cations are illustrated below wherein R¹, R², and R³-R⁵, when present, are as defined before.

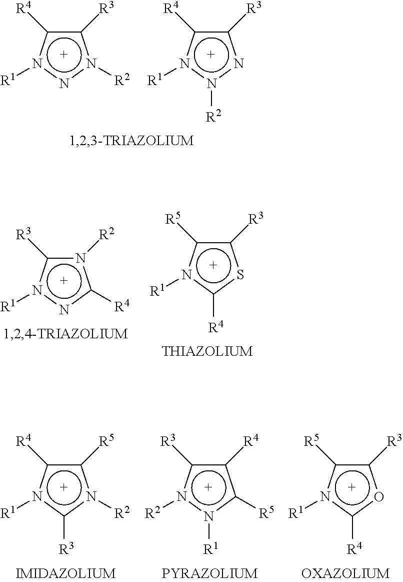

Of the cations that contain a single five-membered ring free of fusion to other ring structures, an imidazolium cation that corresponds in structure to Formula A is also suitable, wherein R¹, R², and R³-R⁵, are as defined before.

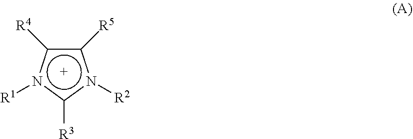

In a further example, an N,N-1,3-di-(C₁-C₆ alkyl)-substituted-imidazolium ion can be used; i.e., an imidazolium cation wherein R³-R⁵ of Formula A are each H, and R¹ and R² are independently each a C₁-C₆ alkyl group or a C₁-C₆ alkoxyalkyl group. In still other examples, a 1-(C₁-C₆-alkyl)-3-(methyl)-imidazolium [Cₙ-mim, where n=1-6] cation and a halogen anion can be used. In yet another example, the cation illustrated by a compound that corresponds in structure to Formula B, below, wherein R³-R⁵ of Formula A are each hydrido and R¹ is a C₁-C₆ -alkyl group or a C₁-C₆ alkoxyalkyl group.

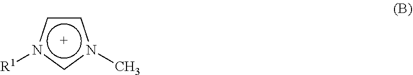

A suitable anion for a contemplated ionic liquid cation is a halogen (fluoride, chloride, bromide, or iodide), perchlorate, a pseudohalogen such as thiocyanate and cyanate or C₁-C₆ carboxylate. Pseudohalides are monovalent and have properties similar to those of halides (Schriver et al., Inorganic Chemistry, W. H. Freeman & Co., New York, 1990, 406-407). Pseudohalides include the cyanide (CN⁻), thiocyanate (SCN⁻), cyanate (OCN⁻), fulminate (CNO⁻), azide (N₃⁻) anions, tetrafluoroborate (BF₄), hexafluorophosphate (PF₆), bis-trifluoromethanesulfonimide (NTf₂), trifluoromethanesulfonate (OTf), dicyanamide (N(CN)₂), hydrogen sulphate (HSO₄), and ethyl sulphate (EtOSO₃). Carboxylate anions that contain 1-6 carbon atoms (C₁-C₆ carboxylate) and are illustrated by formate, acetate, propionate, butyrate, hexanoate, maleate, fumarate, oxalate, lactate, pyruvate, and the like. Still other examples of anions that can be present in the disclosed compositions include, but are not limited to, persulfate, sulfate, sulfites, phosphates, phosphites, nitrate, nitrites, hypochlorite, chlorite, perchlorate, bicarbonates, and the like, including mixtures thereof.

In specific examples, the ionic liquid for the extraction does not contain acid, and acid is not added to the ionic liquid for the extraction step. Acids can be avoided in the extraction step include molecules or ions capable of either donating a proton (Brønsted-Lowry acid) or capable of forming a covalent bond by accepting an electron pair (Lewis acid). Acids can include, but are not limited to, hydrochloric acid, sulfuric acid, nitric acid, acetic acid, carbonic acid, citric acid, acetylsalicylic acid, or any combination thereof. The concentration of acid in the ionic liquid during the extraction step can be less than 10% by weight, less than 5% by weight, less than 2% by weight, less than 1% by weight, less than 0.05% by weight, less than 0.01% by weight, or 0% by weight of the ionic liquid used in the extraction step.

In some embodiments, the ionic liquid can be basic.

In some embodiments, the ionic liquid can include a cation and a basic REE-coordinating anion. As used herein, “REE-coordinating” refers to the ability to form coordination complexes with REEs. A coordination complex includes a metal center bound to surrounding ligands, wherein the metal-ligand bond is a Lewis acid-base interaction. The ligand acts as an electron pair donor (Lewis base) and the metal acts as an electron pair acceptor (Lewis acid). A coordination bond is stronger than intermolecular forces, but weaker than covalent bonds or ionic bonds.

In some embodiments, the ionic liquid can include 1-ethyl-3-methylimidazolium acetate ([C₂mim][OAc]), choline acetate ([Cho][OAc]), octylammonium oleate or any combination thereof. In some embodiments, the ionic liquid can include 1-ethyl-3-methylimidazolium hydrochloride ([C₂mim][HCl₂]), MimSO₃, [HN₂₂₂][Al₂Cl₇], 1-n-butyl-3-methylimidazolium sulfite (SP₃-C₄mim), [MimSO₃H][HSO₄], [MimSO₃H]Cl, ammonium oxalate, ([NH₄][C₂O₄]), non-stoichiometric mixtures of TEAL-based ionic liquids, or any combination thereof.

As used herein, “ionic liquid extraction composition” refers to a composition that includes a combination of a source, such as coal or coal-byproducts, and the ionic liquid. The source can either be dissolved or not dissolved in the ionic liquid. The amount of the ionic liquid used in the ionic liquid extraction composition can include from 1% to 99% by weight of the ionic liquid extraction composition, from 10% to 99%, 30% to 99%, 50% to 99%, 60% to 99%, 80% to 99% by weight of the ionic liquid extraction composition.

In some embodiments, the ionic liquid extraction composition can include the source at a concentration of from 0.005% to 60% by weight of the ionic liquid extraction composition. Further, the ionic liquid extraction composition can include the source at a concentration of from 0.005% to 10%, 10% to 20%, 20% to 30%, 30% to 40%, 40% to 50%, or 50% to 60% by weight of the ionic liquid extraction composition.

In some embodiments, the ionic liquid extraction composition can include the source at a concentration of from 0.5% to 5% by weight of the source. Further, the ionic liquid extraction composition can include the source at a concentration of from 0.5% to 1%, 1% to 2%, 2% to 3%, 3% to 4%, or 4% to 5% by weight of the ionic liquid extraction composition. In some embodiments, the ionic liquid extraction composition can include the source at a concentration of from 0.05% to 0.5% by weight of the ionic liquid extraction composition. Further, the ionic liquid extraction composition can include the source at a concentration of from 0.05% to 0.1%, 0.1% to 0.2%, 0.2% to 0.3%, 0.3% to 0.4%, or 0.4% to 0.5% by weight of the ionic liquid extraction composition. In some embodiments, the ionic liquid extraction composition can include the source at a concentration of from 0.005% to 0.05% by weight of the ionic liquid extraction composition. Further, the ionic liquid extraction composition can include the source at a concentration of from 0.005% to 0.01%, 0.01% to 0.02%, 0.02% to 0.03%, 0.03% to 0.04%, or 0.04% to 0.05% by weight of the ionic liquid extraction composition.

### Contacting

In some embodiments, wherein after contacting the source with the ionic liquid, the source swells or dissolves in the ionic liquid. As used herein, “swelling” refers to a phenomenon associated with physical and morphological changes that occur when coal is steeped in a particular solvent, wherein coal undergoes a volumetric increase in size. Swelling can cause a change in properties, such as thermal, pore, and surface effects. Swelling can include detachment of coal molecules or expansion of bonds between coal molecules. A solvent can dissolve a solute and when dissolving a solute, the solvent can often be a liquid.

In some embodiments, contacting the source with ionic liquid can further include irradiating the ionic liquid and source with microwaves. Irradiating with microwaves can provide heating that is volumetric, direct, selective, instantaneous, and/or controllable, which can allow for fast heating and minimization of temperature excursion.

In some embodiments, contacting the source with ionic liquid can further include irradiating the ionic liquid and source with ultrasound waves. Ultrasound waves can have frequencies greater than 20,000 Hz (20 kHz). Ultrasound, as applied to coal, can fragment, disperse, and/or deagglomerate coal particles, which can promote grinding and/or detachment of impurities from coal particles.

In some embodiments, contacting the source with the ionic liquid can provide a swollen residue.

In some embodiments, contacting the source with the ionic liquid can provide an undissolved residue. As used herein, “undissolved residue” refers to the solid materials that do not dissolve or swell during extraction of REEs and are separated during recovery of the REEs. Undissolved residue can be separated during recovery via centrifugation, chromatographic separation, solvent extraction, acidification, addition of sorbents, resin separation, adding anti-solvent, electroprecipitation, or any combination thereof.

In some embodiments, contacting the source with ionic liquid can further includes dissolving metal salts, metal hydroxides, metal oxides, or any combination thereof in the ionic liquid extraction composition. In some embodiments, contacting the source with ionic liquid can further includes dissolving REE salts, REE hydroxides, REE oxides, or any combination thereof in the ionic liquid extraction composition. REE salts can include, but are not limited to, cerium (III) nitrate, dysprosium chloride, erbium chloride, gadolinium oxide, or europium (III) fluoride. REE hydroxides can include, but are not limited to, erbium hydroxide, gadolinium hydroxide, or dysprosium hydroxide. REE oxides can include, but are not limited to, cerium (IV) oxide, dysprosium oxide, erbium oxide, or gadolinium oxide. The actinide series encompasses the 15 metallic chemical elements with atomic numbers from 89 to 103. Specific REE oxides include actinide oxides such as actinium oxide, thorium oxide, or curium oxide.

In some embodiments, the ionic liquid and source can be mixed, wherein mixing can include, but is not limited to, stirring, vortexing, agitating, blending, or any combination thereof.

In some embodiments, contacting the source with ionic liquid can be performed for from 1 second to 10 hours, for example, from 1 second to 1 hour, from 1 second to 30 minutes, from 1 second to 15 minutes, from 1 second to 5 minutes, from 1 second to 1 minute, from 1 minute to 1 hour, from 1 hour to 10 hours, from 5 hours to 10 hours, or from 1 hour to 2 hours.

In some embodiments, contacting the source with ionic liquid can be performed at a temperature from 0° C. to 120° C. Further, contacting the source with ionic liquid can be performed at a temperature from 0° C. to 20° C., 20° C., to 40° C., 40° C. to 60° C., 60° C. to 80° C., 80° C. to 100° C., or 100° C. to 120° C. In some embodiments, contacting the source with ionic liquid can be performed at a temperature from 80° C. to 120° C. Further, contacting the source with ionic liquid can be performed at a temperature from 80° C. to 85° C., 85° C. to 90° C., 90° C. to 95° C., 95° C. to 100° C., 100° C. to 105° C., 105° C. to 110° C., 110° C. to 115° C., or 115° C. to 120° C.

### Recovering

In some embodiments, from 50% to 100% of the metals present in the source can be extracted. For example, from 50% to 70%, from 60% to 80%, from 70% to 90%, from 80% to 100%, from 90% to 100% of the metals present (e.g., REEs, alkali metals, alkaline earth metals, or transition metals) in the source can be extracted.

In specific examples, from 50% to 100% of REEs, from 70% to 100%, or from 90% to 100% of REEs present in the source can be extracted. Further, from 90% to 92%, from 92% to 94%, 94% to 96%, 96% to 98%, or 98% to 100% of REEs present in the source can be extracted.

In some embodiments, the method can further include removing the swollen residue from the ionic liquid extraction composition.

In some embodiments, the method can further include removing the undissolved residue from the ionic liquid extraction composition. In some embodiments, the method can further include contacting the undissolved residue with the ionic liquid.

In some embodiments, recovering the metals from the ionic liquid extraction composition can include adding base, ionic liquid, or any combination thereof. Bases can include sodium hydroxide, potassium hydroxide, magnesium hydroxide, calcium hydroxide, aluminum hydroxide, ammonia, or any combination thereof.

In some embodiments, recovering the metals from the ionic liquid extraction composition can include acidification of the ionic liquid extraction composition to precipitate the metals from the ionic liquid extraction composition. Acidification refers to the process of adding acid to a composition. Acidification of a solution including coal and ionic liquid can provide products such as an aqueous layer of REEs, a solid carbonaceous layer, and/or an oil layer.

In some embodiments, recovering the metals from the ionic liquid extraction composition can include solvent extraction of the metals from the ionic liquid extraction composition. Solvent extraction refers to a process in which a compound transfers from one solvent to another owing to the difference in solubility or distribution coefficient between the two immiscible or slightly soluble solvents. Solvent extraction can separate compounds or metal complexes. One of the two solvents involved in solvent extraction can include water, while the other solvent can include organic solvent, for example, toluene, benzene, xylene, or any combination thereof. Solvent extraction techniques can include batchwise single stage extractions, dispersive liquid-liquid microextraction, or direct organic extraction. The quantity of solvent used can vary, as the maximum quantity of solute that can dissolve in a specific volume of solvent varies with temperature and pressure. Solvents can include, but are not limited to, water, ethanol, methanol, acetone, tetrachloroethylene, toluene, methyl acetate, ethyl acetate, hexane, benzene, or any combination thereof.

In some embodiments, recovering the metals from the ionic liquid extraction composition can include adding sorbents to the ionic liquid extraction composition to adsorb the metals. Three types of sorbents include natural organic, natural inorganic, and synthetic sorbents. Natural organic sorbents include, but are not limited to, peat moss, straw, hay, sawdust, ground corncobs, feathers, or any combination thereof. Natural inorganic sorbents include, but are not limited to clay, perlite, vermiculite, glass wool, sand, volcanic ash, or any combination thereof. Synthetic sorbents include, but are not limited to, plastics, such as polyurethane, polyethylene, and polypropylene, cross-linked polymers, rubber materials, or any combination thereof.

In some embodiments, recovering the metals from the ionic liquid extraction composition can include contacting the ionic liquid extraction composition to a resin. In some embodiments, performing resin separation can further include treating the resin with acid. Resin separation refers to the process of separating and purifying metals wherein dissolved ions are removed from solution and replaced with other ions of the same or similar electrical charge. Examples of resins include, but are not limited to, sodium polystyrene sulfonate, colestipol, and cholestyramine.

In some embodiments, recovering the metals from the ionic liquid extraction composition can include adding anti-solvent to the ionic liquid extraction composition to remove the ionic liquid. Anti-solvents can include, but are not limited to, chlorobenzene, benzene, xylene, toluene, methanol, ethanol, ethylene glycol, 2-propanol, chloroform, tetrahydrofuran, acetonitrile, benzonitrile, or any combination thereof.

In some embodiments, recovering the metals from the ionic liquid extraction composition can include electroprecipitation to precipitate metals as insoluble hydroxides by increasing the concentration of OH⁻ at an electrode surface. Electroprecipitation can include electrochemically inducing precipitation of the material as insoluble hydroxides. Electroprecipitation can operate via a mechanism in which the concentration of OH⁻ at an electrode surface is increased, resulting in precipitation of the material as insoluble hydroxides. (See Example 1. Obtaining REEs with ILs.)

In some embodiments, recovering the metals from the ionic liquid extraction composition can further include centrifuging the ionic liquid extraction composition. Centrifuge refers to separating fluids of different densities or liquids from solids and can include differential centrifugation or density gradient centrifugation. Examples of density gradient centrifugation can include rate-zonal centrifugation or isopycnic centrifugation.

### Composition

The present disclosure also provides for a carbon material made by a process that includes contacting a source with an ionic liquid in the absence of acid, thereby extracting metals from the source and providing an ionic liquid extraction composition; and recovering the metals from the ionic liquid extraction composition, wherein the source includes coal, coal by-products, ore, tar, or electronic waste, further wherein the carbon material includes solids, liquids, carbon films, carbon fibers, carbon nanomaterials, or any combination thereof.

Carbon materials can include, but are not limited to, graphite, carbon felt, carbon foam, carbon paper, carbon brush, and carbon cloth. Carbon materials can also include coal-based carbon materials, such as carbon films, carbon fibers, and carbon nanomaterials. Carbon film refers to thin film coating that include primarily carbon. Carbon films can include, but are not limited to, plasma polymer films, amorphous carbon films, CVD diamond films, and graphite films. Carbon films can be produced by deposition using gas-phase deposition processes. They can be deposited in the form of thin films with a thickness from 1 μm-5 μm. Carbon fiber refers to material that includes crystalline filaments of carbon, wherein the carbon is approximately from 5 to 10 micrometers in diameter. Carbon fibers can include, but are not limited to, isotropic-pitch-based carbon fibers and anisotropic mesophase-pitch-based carbon fibers. Carbon nanomaterial refers to nanomaterials that include carbon atoms, wherein nanomaterials are materials containing particles with at least one dimension between 1 and 100 nm in size. Carbon nanomaterials can include, but are not limited to, graphene, graphene oxide, carbon quantum dots, carbon nanotubes, or any combination thereof.

### EXAMPLES

To further illustrate the principles of the present disclosure, the following examples are put forth so as to provide those of ordinary skill in the art with a complete disclosure and description of how the compositions, articles, and methods claimed herein are made and evaluated. They are intended to be purely exemplary of the invention and are not intended to limit the scope of what the inventors regard as their disclosure. These examples are not intended to exclude equivalents and variations of the present invention which are apparent to one skilled in the art. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1

### Obtaining REEs With ILs

The examples described herein demonstrate the extraction of REEs and other products from coal, ash, waste, ore, or other sources of REEs in a time effective and environmentally-compatible manner. A treatment process was developed and demonstrated that reproducibly extracted from 92% to 100% of REEs from coal after two minutes of treatment without acid. Experimental data indicated extraction of REEs from any REE-containing materials.

The disclosure described herein comprises the extraction of REEs directly from coal and other REE-containing materials into an ionic liquid (IL) solution and the isolation of the REEs from the solution. Also disclosed is the use of microwave processing to increases the efficiency of the extraction and the isolation of many co-products including carbon materials, chemicals, and other high value metals. Also disclosed is an electrochemical method for recovery of REE solids from IL-containing or aqueous solutions.

A process was developed using task-specific ILs with ions that can solubilize and react with coal, coal by-products, or other REE-containing materials to extract the REEs and other co-products (minor metals, carbon materials) into solution. REEs were then isolated and recovered from this solution along with extracted solid and extracted liquid feed streams containing other metals and carbonaceous materials.

This example demonstrates the processing of coal, coal by-products, waste, or REE-containing ore (e.g., coal, fly ash, carbonatite) through the swelling and/or dissolution of these source products in the IL and extraction of REEs into solution. Further REE and co-product isolation was achieved through one or more streams, including, but not limited to, centrifugation, resin separation, acidification, solvent extraction. Recovery steps included evaporation, chromatographic separations, and a new method of electroprecipitation described herein which can be used with the IL-containing solutions and aqueous solutions recovered from coal/IL solution. By dissolving and/or swelling of the REE-containing materials in the IL, the REEs and other constituents (e.g., carbon materials, metals, chemicals) were extracted into new compositions from which new materials were generated.

In this example, one or more ILs were used to directly extract REEs from REE-containing materials without acid. Several ILs, including a single basic IL requiring no acid, directly extracted REEs from REE-containing material into solution. Further, a liquid solution of REEs and coal or waste products and swollen REE-containing material residue were all used to develop additional co-products. Basic, REE-coordinating IL extracted REEs directly into solution, making isolation and recovery easier and eliminating the need to use acid or other solvent.

In summary, REEs and co-products, including carbonaceous materials, chemicals, and other materials, were extracted from REE-containing materials (e.g., coal, coal by-products, ore, e-waste) into an IL as a solution. Basic coordinating ILs were used, with or without microwave processing, to dissolve and/or swell REE-containing materials to extracts REEs.

The general experimental procedure demonstrated was as follows. Source materials (e.g., coal, ash, ore, waste), with or without pretreatment (grinding/drying), were weighed, then the IL or control solvents were added at specific weight ratios (wt. %, by weight of source to IL), mixed via stirring or vortexing, and treated with a specific heat or microwave treatment/mixing regime for a certain amount of time. Treatments included room temperature stirring (T1), oil/sand bath heating at 100° C. with stirring (T2), and microwave pulsing (2-3 sec) with stirring (T3). Microwave treatment resulted in very short extraction times (several orders of magnitude shorter than T2 or T1). Following treatment, samples were centrifuged to separate undissolved solids (residues) from dissolved source solution, and analyzed by various methods (e.g., ICP-MS, optical particulate analyses). (See Table 1.)

Dissolution and/or swelling were both observed with coal and other REE-source materials. Experimental data indicated that the amount of REEs and co-products extracted via this method was controlled by “source” material (e.g., coal, ash, ore, waste), IL type, source to IL ratio (generally in wt. % by weight of source to IL), duration and type of treatment, and solution temperature (see further Example 12, Table 7). Extraction percentages were modified for a single extraction at low wt. percentages (˜100% in one pass), or sequential extractions at higher wt. percentages (5% and 10% have been demonstrated). Higher wt. % of coal to IL resulted in increased extraction of carbonaceous materials and overall dissolution. Sequential passes with the same treatments resulted in further extractions. (See further Example 12). An efficient microwave treatment system was developed that can extract >92% REEs from coal in ˜2 minutes. Traditional extraction methods (e.g., resin/sorbent recovery) were found to work with the extracted REE solutions. (See further Example 16.)

An electrochemical method for the recovery of REEs from 1) IL-containing solutions (such as coal/IL) and 2) aqueous solutions after preconcentration (resins, etc.) was also demonstrated. Electrochemical recovery from the initial source/IL solutions and the preconcentrated aqueous solutions mimicking resin-recovered REEs were investigated. The electrode potentials required for the direct deposition of REEs as metals (i.e., M^{z+}+ze⁻→M) were found to fall outside of the usable potential window of the IL chosen for dissolution, preventing direct recovery as metals. In response to this observation, the electrochemically induced precipitation of REEs as insoluble hydroxides was developed. Such a scheme operates via the following mechanism:

2H₂O₍ₗ₎+2e⁻→H_{2(g)}+2OH_{(aq)}⁻

M_{(aq)}^{z+}+zOH_{(aq)}⁻→M(OH)_{z(s)}

In effect, the concentration of OH⁻ the electrode surface was increased, resulting in precipitation of REEs as insoluble hydroxides.

This process was demonstrated in both (1) preconcentrated aqueous solutions (e.g., those which would resemble aqueous eluents from process resins confirmed to work with this system) and (2) diluted CRC/IL #1 solutions. Proof-of-concept data is provided in Examples 23-26, which gives photographs of electrode deposits which were confirmed to be REEs via PXRD (Example 23). The dilution factors required to successfully recover REEs directly from the coal-IL solutions were found to be high (>10×), however, the system lent itself to a straightforward recyclability of these aqueous solutions. We systematically examined how various parameters such as the electrode potential employed in the recovery process affected selectivity.

Additional co-products resulted from the compositions generated by method, including extracted liquid, oil, and solid streams. Further co-products included carbon materials (e.g., carbon fibers, nanomaterials), chemicals, and critical minerals (e.g., Li, Co), which were found in the extracted fractions. The process was tuned to extract specific materials in greater amounts. The co-dissolution of biopolymers (e.g., cellulose, chitin) with the coal/IL solution and the generation of novel coal/biopolymeric materials was also demonstrated.

### Example 2

### General Experimental Procedure

The experimental procedure for the experiments described in Table 1 were as follows. Source materials with or without pretreatment (grinding/drying) were weighed, then IL or control solvents were added at specific weight ratios (wt. %, by weight of source to IL), mixed, and treated with a specific treatment/mixing regime for a certain amount of time. Samples were centrifuged to separate undissolved solids from dissolved source solution, and analyzed by various methods (ICP-MS, optical particulate analyses, etc.). Specifics of the treatments and variables are below. Experimental number is an assigned value to identify a particular sample.

The source materials were any REE-containing samples, including: 1) CRC: Cordero Rojo Coal, subbituminous coal from the Cordero Rojo mine in the Powder River Basin in WY, 2) FA: Fly Ash from North Powder River Basin, 3) BA: Bottom Ash from a Landfill in the North Powder River Basin, 4) CKR: clinker waste from burned coal at a WY coal power plant (glassy-fused mineral waste, also known as slag), 5) CARB: carbonatite mineral with high REE-content, 6) CLB-1: Lower Bakersfield Coal from PA, received from the USGS, medium volatile bituminous coal, 7) AL-1: Alabama Coal, received from a single mine in AL, 8) REEOAc: REE salt in acetate form, 9) REECl: REE salt in chloride form, 10) ASPH: asphaltenes from crude oil, 11) REEOx: REE solids in oxide form, 12) REEHyd: REE solids in hydroxide form, or a previous sample indicated by experimental number.

The ionic liquids (ILs) were either purchased or synthesized in house. Other solvents were purchased and prepared as necessary. ILs used were 1) IL #1: 1-ethyl-3-methylimidazolium acetate ([C₂mim][OAc]), 2) IL #2: 1-ethyl-3-methylimidazolium hydrochloride ([C₂mim][HCl₂]), 3) IL #3: MimSO₃, 4) IL #4: [HN₂₂₂][Al₂Cl₇], 5) IL #5: 1-n-butyl-3-methylimidazolium sulfite (SO₃-C₄mim), 6) IL #6: [MimSO₃H][HSO₄], 7) IL #7: [MimSO₃H]Cl, 8) IL #8: choline acetate ([Cho][OAc]), 9) IL #9: ammonium oxalate, ([NH₄][C₂O₄]), 10) IL #10: Non-Stoichiometric mixtures of TEAL-based ILs. Solvents used for comparison and further processing included: water (H₂O), acetone, acetic acid, nitric acid, toluene, hexane, ethyl acetate, hydrochloric acid, sodium hydroxide, xylene, and other typical solvents.

The weight ratio (wt. %) represents the initial source to ionic liquid ratio or source to solvent ratio of the initial mixture.

The source materials were either ground or not ground. Samples were ground with an IKA universal batch mill and put through one or more sieves resulting in 1) <45 μm grind, 2) <125 μm grind, 3) <250 μm grind, or 4) no sieve. A number of samples were ground with either a mortar and pestle or spatula and are indicated as such. Samples ground the day of the experiment were considered “fresh.” The approximate time after grind for periods longer than 24 hours before treatment are indicated in the “time after grind” column.

Samples are considered “wet” if no additional drying was performed. All samples were weighed wet and sample mass is in the wet form. Samples that are “dry” were dried in the oven at —100° C. overnight to remove the water content. Loss of water content was confirmed via mass difference.

Treatments were performed with stirring and/or vortexing and included 1) T1: room temperature treatment with stirring, 2) T2: oil or sand bath treatment at 100° C. with stirring, and 3) T3: microwave pulse treatment with stir and/or vortex or a combination of treatments. T1 and T2 were performed on a stirring hotplate with or without heat. T3 was performed with a commercial microwave in 2-3 second pulses of microwave irradiation, which prevents decomposition of the ILs. The time of treatment is the amount of total heating time for the sample.

Samples were centrifuged using a ThermoFisher Sorvall ST-8 centrifuge at the RPM and time indicated in the spin column. Solutions of sample/IL or sample/solvent were separated from the residue, observed for particulate, and centrifuged more if needed until particulate-free. Solutions and residues were sent for ICP-MS analyses. Total spin time is listed in the spin column. Any additional observations are noted in the final column.

TABLE 1
Experiments.

| # | Source | Source (g) | Ionic Liquid (IL) | IL, g | Solvent | Solvent (g) | Ground | | Wet/Dry | wt. % | Treatment | Time | | Spin | Observations |
|---|---|---|---|---|---|---|---|---|---|---|---|---|---|---|---|
| 1 | CRC | 0.200 | IL#1 | 4.000 | | | <250 | μm | wet | 4.76% | T2 | 8 | h | 4000 RPM, | Black solution with some residue |
| | | | | | | | | | | | | | | 30 min | |
| 2 | CRC | 0.200 | IL#2 | 4.000 | | | <250 | μm | wet | 4.76% | T2 | 8 | h | 4000 RPM, | Black solution with some residue |
| | | | | | | | | | | | | | | 30 min | |
| 3 | CRC | 0.200 | IL#3 | 4.000 | | | <250 | μm | wet | 4.76% | T2 | 8 | h | 4000 RPM, | Solid at RT, liquid at 100° C. |
| | | | | | | | | | | | | | | 30 min | |
| 4 | CRC | 0.200 | IL#4 | 4.000 | | | <250 | μm | wet | 4.76% | T2 | 8 | h | 4000 RPM, | Black solution with some residue, |
| | | | | | | | | | | | | | | 30 min | Al-oxide in addition to the unreacted coal |
| 5 | CRC | 0.200 | IL#5 | 4.000 | | | <250 | μm | wet | 4.76% | T2 | 8 | h | 4000 RPM, | Solid at RT, liquid at 100° C. |
| | | | | | | | | | | | | | | 30 min | |
| 6 | CRC | 0.200 | IL#6 | 4.000 | | | <250 | μm | wet | 4.76% | T2 | 8 | h | 4000 RPM, | IL very viscous, could not remove |
| | | | | | | | | | | | | | | 30 min | particulate with centrifugation |
| 7 | CRC | 0.200 | IL#7 | 4.000 | | | <250 | μm | wet | 4.76% | T2 | 8 | h | 4000 RPM, | IL very viscous, could not remove |
| | | | | | | | | | | | | | | 30 min | particulate with centrifugation |
| 8 | CRC | 0.500 | IL#1 | 10.000 | — | | no sieve | | wet | 4.76% | T2 | 8 | h | 2000 RPM, | Dark black, viscous |
| | | | | | | | | | | | | | | 30 min | |
| 9 | FA | 0.250 | IL#1 | 5.000 | | | no sieve, | | wet | 4.76% | T1 | 2 | days | 4000 RPM, | light gray mixture |
| | | | | | | | ash | | | | | | | 30 min | |
| 10 | BA | 0.250 | IL#1 | 5.000 | | | no sieve, | | wet | 4.76% | T1 | 2 | days | 4000 RPM, | yellow layer (S) separation, even |
| | | | | | | | ash | | | | | | | 30 min | without mixing |
| 11 | FA | 0.250 | IL#1 | 5.000 | | | no sieve, | | wet | 4.76% | T2 | 7 | h | 4000 RPM, | dark gray, layered, tiny stable bubble |
| | | | | | | | ash | | | | | | | 30 min | layer, middle cloudy layer taken for ICP-MS |
| 12 | BA | 0.250 | IL#1 | 5.000 | | | no sieve, | | wet | 4.76% | T2 | 7 | h | 4000 RPM, | yellow separation remains, dark gray |
| | | | | | | | ash | | | | | | | 30 min | mixture |
| 13 | CRC | 0.501 | IL#1 | 10.005 | | | no sieve | | wet | 4.77% | T2 | 8 | h | 4000 RPM, | Dark black mixture |
| | | | | | | | | | | | | | | 30 min | |
| 14 | CRC | | IL#1 | | | | | | wet | 5% | T2 | 8 | h | 4000 RPM, | Dark black mixture |
| | | | | | | | | | | | | | | 30 min | |
| 15 | — | | IL#1 | | | | | | — | | — | — | | — | IL only |
| 16 | CRC | 0.495 | IL#1 | 10.010 | | | <45 | μm | dry | 4.71% | T2 | 8 | h | 10000 RPM, | 0.495 to 0.4 after dry, 19% mass loss, |
| | | | | | | | | | | | | | | 10 min | residue gained mass, add acetone to |
| | | | | | | | | | | | | | | | residue and something else came out, |
| | | | | | | | | | | | | | | | also residue exploded in the oven |
| | | | | | | | | | | | | | | | w/IL or w/acetone |
| 17 | #16 | 0.181 | | | H₂O | 9.97 | | | | | | | | | Initially in solution (brown) without |
| | | | | | | | | | | | | | | | visible particulate. Precipitate falls |
| | | | | | | | | | | | | | | | out over time (overnight) or with |
| | | | | | | | | | | | | | | | spin, goes back into solution with a |
| | | | | | | | | | | | | | | | quick shake. |
| 18 | #16 | 0.184 | | | H₂O | 8.82 | | | | 2.04% | | | | | In solution, but falls out over time or |
| | | | | | | | | | | | | | | | with spin |
| 19 | #20 | 0.182 | | | H₂O | 8.849 | | | | 2.02% | | | | | In solution, but falls out over time or |
| | | | | | | | | | | | | | | | with spin |
| 20 | CRC | 0.500 | IL#1 | 10.000 | | | <45 | μm | wet | 4.76% | T2 | 8 | h | 10000 RPM, | darker and more viscous than pre- |
| | | | | | | | | | | | | | | 10 min | dried sample |
| 21 | CRC | 0.050 | IL#1 | 1.000 | | | <45 | μm | wet | 4.76% | T3 | 2 | min | 10000 RPM, | Dark black, more viscous than T2 or T1 |
| | | | | | | | | | | | | | | 10 min | |
| 22 | #21 | 0.18 | | | H₂O | 8.9 | | | | | | | | | Much darker #21, same observations: |
| | | | | | | | | | | | | | | | in solution but precipitation over time |
| | | | | | | | | | | | | | | | (faster than dry or wet T2) ~30 min, |
| | | | | | | | | | | | | | | | “fluffy” or gelatinous looking |
| | | | | | | | | | | | | | | | precipitation, goes back in solution |
| | | | | | | | | | | | | | | | quickly with shake |
| 23 | CRC | 0.100 | | | Acetone | 2.043 | <45 | μm | wet | 4.67% | T1 | | | | Slight orange appearance after days |
| 24 | CRC | 0.500 | IL#1 | 9.500 | | | <125 | μm | wet | 5.00% | T3 | 2 | min | | As stated in other examples, dark |
| | | | | | | | | | | | | | | | black mixture then solution obtained, viscous |
| 25 | CRC | 0.500 | IL#1 | 9.500 | | | <125 | μm | wet | 5.00% | T3 | 4 | min | | No difference observed from 2 min |
| 26 | CRC | 0.500 | IL#1 | 9.500 | | | <125 | μm | wet | 5.00% | T3 | 6 | min | | No difference observed from 2 min or |
| | | | | | | | | | | | | | | | 4 min treatment |
| 27 | CRC | 0.500 | IL#1 | 9.511 | | | <125 | μm | wet | 4.99% | T1 | 10 | min | 4000 RPM, | 10 min T1 resulted in a light brown |
| | | | | | | | | | | | | | | 15 min | solution |
| 28 | CRC | 0.500 | IL#1 | 9.510 | | | <125 | μm | wet | 5.00% | T1 | 24 | h | 4000 RPM, | 24 h T1 is darker than 10 min T1 |
| | | | | | | | | | | | | | | 15 min | |
| 29 | CRC | 0.500 | IL#1 | 9.509 | | | <125 | μm | wet | 5.00% | T2 | 24 | h | 4000 RPM, | strong smell, tar-like |
| | | | | | | | | | | | | | | 15 min | |
| 30 | CRC | 0.500 | IL#1 | 9.508 | | | <125 | μm | wet | 5.00% | T3 | 2 | min | 4000 RPM, | very hot after 9 sec MW, steam/white |
| | | | | | | | | | | | | | | 15 min | after 30 sec, strong smell |
| 31 | CRC | 0.500 | IL#1 | 9.518 | | | <125 | μm | dry | 4.99% | T2 | 24 | h | 4000 RPM, | drying lost 27.3% moisture, average |
| | | | | | | | | | | | | | | 15 min | |
| 32 | CRC | 0.450 | IL#1 | 9.522 | | | <125 | μm | dry | 4.51% | T3 | 2 | min | 4000 RPM, | drying lost 27.3% moisture, average, |
| | | | | | | | | | | | | | | 15 min | smaller particulate and less sticking |
| | | | | | | | | | | | | | | | to side compared to wet |
| 33 | CRC | 0.501 | IL#1 | 9.523 | | | <125 | μm | dry | 5.00% | T1 | 24 | h | 4000 RPM, | drying lost 27.3% moisture, average |
| | | | | | | | | | | | | | | 15 min | |
| 34 | FA | 0.500 | IL# | 9.502 | | | no sieve, | | wet | 5.00% | T1 | 24 | h | 4000 RPM, | black particulate on stir bar, bubble |
| | | | | | | | ash | | | | | | | 15 min | layer on top |
| 35 | FA | 0.438 | IL#1 | 9.508 | | | no sieve, | | wet | 4.40% | T3 | 2 | min | 4000 RPM, | black on stir bar, bubble layer on top, |
| | | | | | | | ash | | | | | | | 15 min | dark green/grey after treatment |
| 36 | FA | 0.500 | IL#1 | 9.509 | | | no sieve, | | wet | 5.00% | T2 | 24 | h | 4000 RPM, | black on magnet, bubble layer on top |
| | | | | | | | ash | | | | | | | 15 min | |
| 37 | FA | 0.501 | IL# | 9.532 | | | no sieve, | | wet | 4.99% | T1 | 10 | min | 4000 RPM, | |
| | | | | | | | ash | | | | | | | 15 min | |
| 38 | CRC | 0.600 | IL# | 9.526 | | | <125 | μm | dry | 5.52% | T3 | 2 | min | 4000 RPM, | drying lost 27.3% moisture, average |
| | | | | | | | | | | | | | | 15 min | |
| 39 | #27 | 0.516 | | | H₂O | 4.669 | | | | 9.95% | | | | 4000 RPM, | H₂O addition to CRC/IL#1 solution |
| | | | | | | | | | | | | | | 15 min | resulted in precipitation of new |
| | | | | | | | | | | | | | | | composition upon spin |
| 40 | #28 | 0.518 | | | H₂O | 4.676 | | | | 9.97% | | | | 4000 RPM, | H₂O addition to CRC/IL#1 solution |
| | | | | | | | | | | | | | | 15 min | resulted in precipitation of new |
| | | | | | | | | | | | | | | | composition upon spin |
| 41 | #29 | 0.505 | | | H2C | 4.649 | | | | 9.80% | | | | 4000 RPM, | H₂O addition to CRC/IL#1 solution |
| | | | | | | | | | | | | | | 15 min | resulted in precipitation of new |
| | | | | | | | | | | | | | | | composition upon spin |
| 42 | #30 | 0.52 | | | H₂O | 4.762 | | | | 9.84% | | | | 4000 RPM, | H₂O addition to CRC/IL#1 solution |
| | | | | | | | | | | | | | | 15 min | resulted in precipitation of new |
| | | | | | | | | | | | | | | | composition upon spin |
| 43 | #31 | 0.516 | | | H₂O | 4.69 | | | | 9.91% | | | | 4000 RPM, | H₂O addition to CRC/IL#1 solution |
| | | | | | | | | | | | | | | 15 min | resulted in precipitation of new |
| | | | | | | | | | | | | | | | composition upon spin |
| 44 | #32 | 0.503 | | | H₂O | 4.548 | | | | 9.96% | | | | 4000 RPM, | H₂O addition to CRC/IL#1 solution |
| | | | | | | | | | | | | | | 15 min | resulted in precipitation of new |
| | | | | | | | | | | | | | | | composition upon spin |
| 45 | #33 | 0.508 | | | H₂O | 4.64 | | | | 9.87% | | | | 4000 RPM, | H₂O addition to CRC/IL#1 solution |
| | | | | | | | | | | | | | | 15 min | resulted in precipitation of new |
| | | | | | | | | | | | | | | | composition upon spin |
| 46 | #34 | 0.521 | | | H₂O | 4.776 | | | | 9.84% | | | | 4000 RPM, | H₂O addition to FA/IL#1 solution, |
| | | | | | | | | | | | | | | 15 min | immediately bubbled |
| 47 | #35 | 0.522 | | | H₂O | 4.73 | | | | 9.94% | | | | 4000 RPM, | H₂O addition to FA/IL#1 solution, |
| | | | | | | | | | | | | | | 15 min | immediately bubbled |
| 48 | #36 | 0.517 | | | H₂O | 4.754 | | | | 9.81% | | | | 4000 RPM, | H₂O addition to FA/IL#1 solution, |
| | | | | | | | | | | | | | | 15 min | immediately bubbled |
| 49 | #37 | 0.509 | | | H₂O | 4.61 | | | | 9.94% | | | | 4000 RPM, | H₂O addition to FA/IL#1 solution, |
| | | | | | | | | | | | | | | 15 min | immediately bubbled |
| 50 | #38 | 0.518 | | | H₂O | 4.724 | | | | 9.88% | | | | 4000 RPM, | |
| | | | | | | | | | | | | | | 15 min | |
| 51 | CRC | 0.500 | IL#1 | 9.500 | | | <125 | μm | wet | 5.00% | T2 with | 24 | h | 4000 RPM, | No obvious difference with vacuum |
| | | | | | | | | | | | vacuum | | | 15 min | |
| 52 | #51 | 0.503 | | | H₂O | 4.5 | | | | 10.05% | | | | 4000 RPM, | H₂O addition to CRC/IL#1 solution |
| | | | | | | | | | | | | | | 15 min | resulted in precipitation of new |
| | | | | | | | | | | | | | | | composition upon spin |
| 53 | CRC | 0.501 | | | H₂O | 9.53 | <125 | μm | wet | 4.99% | T3 | 2 | min | 4000 RPM, | |
| | | | | | | | | | | | | | | 15 min | |
| 54 | CRC | 0.498 | | | H₂O | 9.502 | <125 | μm | wet | 4.98% | T1 | 27 | h | 4000 RPM, | solution light brown |
| | | | | | | | | | | | | | | 15 min | |
| 55 | FA | 0.504 | | | H₂O | 9.56 | no sieve, | | wet | 5.01% | T3 | 2 | min | 4000 RPM, | floating stuff, white |
| | | | | | | | ash | | | | | | | 15 min | |
| 56 | FA | 0.500 | | | H₂O | 9.5 | no sieve, | | wet | 5.00% | T1 | 27 | h | 4000 RPM, | |
| | | | | | | | ash | | | | | | | 15 min | |
| 57 | CRC | 0.503 | IL#1 | 9.518 | | | <125 | μm | wet | 5.02% | T1 | 24 | h | 4000 RPM, | does not stir well in IL at RT because |
| | | | | | | | | | | | | | | 10 min | of viscosity, sequential dissolutions, |
| | | | | | | | | | | | | | | | first treatment seems to absorb IL, |
| | | | | | | | | | | | | | | | sequential treatments do not. |
| 58 | #57R | 0.503 | IL#1 | 9.515 | | | no | | wet | 5.02% | T1 | 24 | h | 4000 RPM, | Sequential dissolves more CRC |
| | | | | | | | additional | | | | | | | 10 min | residue, visually black and ICP-MS |
| | | | | | | | | | | | | | | | confirmed additional extraction of REEs |
| 59 | #58R | 0.503 | IL#1 | 9.509 | | | no | | wet | 5.02% | T1 | 24 | h | 4000 RPM, | Sequential dissolves more CRC |
| | | | | | | | additional | | | | | | | 10 min | residue, visually black and ICP-MS |
| | | | | | | | | | | | | | | | confirmed additional extraction of REEs |
| 60 | #59R | 0.503 | IL#1 | 9.504 | | | no | | wet | 5.03% | T1 | 24 | h | 4000 RPM, | CRC residue, visually black and ICP- |
| | | | | | | | additional | | | | | | | 10 min | 2 layers, Sequential dissolves more |
| | | | | | | | | | | | | | | | MS confirmed additional extraction of REEs |
| 61 | CRC | 0.505 | IL#1 | 9.518 | | | <125 | μm | wet | 5.04% | T1 | 24 | h | 4000 RPM, | does not stir well in IL at RT because |
| | | | | | | | | | | | | | | 10 min | of viscosity |
| 62 | CRC | 0.504 | | | H₂O | 9.541 | <125 | μm | wet | 5.02% | T1 | 24 | h | 4000 RPM, | 2 layers |
| | | | | | | | | | | | | | | 10 min | |
| 63 | #62R | 0.504 | | | H₂O | 9.505 | no | | wet | 5.04% | T1 | 24 | h | 4000 RPM, | 2 layers |
| | | | | | | | additional | | | | | | | 10 min | |
| 64 | #63R | 0.504 | | | H₂O | 9.51 | no | | wet | 5.03% | T1 | 24 | h | 4000 RPM, | 2 layers |
| | | | | | | | additional | | | | | | | 10 min | |
| 65 | #64R | 0.504 | | | H₂O | 9.499 | no | | wet | 5.04% | T1 | 24 | h | 4000 RPM, | 2 layers |
| | | | | | | | additional | | | | | | | 10 min | |
| 66 | CRC | 0.500 | IL#1 | 9.512 | | | <125 | μm | wet | 4.99% | T3 | 2 | min | 4000 RPM, | First treatment in sequential trial, |
| | | | | | | | | | | | | | | 10 min | treated residue after initial treatment |
| | | | | | | | | | | | | | | | with additional, identical treatments |
| 67 | #66R | 0.500 | IL#1 | 9.501 | | | no | | wet | 5.00% | T3 | 2 | min | 4000 RPM, | Sequential dissolves more CRC |
| | | | | | | | additional | | | | | | | 10 min | residue, visually black and ICP-MS |
| | | | | | | | | | | | | | | | confirmed additional extraction of REEs |
| 68 | #67R | 0.500 | IL#1 | 9.505 | | | no | | wet | 5.00% | T3 | 2 | min | 4000 RPM, | Sequential dissolves more CRC |
| | | | | | | | additional | | | | | | | 10 min | residue, visually black and ICP-MS |
| | | | | | | | | | | | | | | | confirmed additional extraction of |
| | | | | | | | | | | | | | | | REEs |
| 69 | #68R | 0.500 | IL#1 | 9.516 | | | no | | wet | 4.99% | T3 | 2 | min | 4000 RPM, | Sequential dissolves more CRC |
| | | | | | | | additional | | | | | | | 10 min | residue, visually black and ICP-MS |
| | | | | | | | | | | | | | | | confirmed additional extraction of |
| | | | | | | | | | | | | | | | REEs |
| 70 | #69R | 0.500 | IL#1 | 9.521 | | | no | | wet | 4.99% | T3 | 2 | min | 4000 RPM, | Sequential dissolves more CRC |
| | | | | | | | additional | | | | | | | 10 min | residue, visually black and ICP-MS |
| | | | | | | | | | | | | | | | confirmed additional extraction of |
| | | | | | | | | | | | | | | | REEs |
| 71 | #70R | 0.500 | IL#1 | 9.522 | | | no | | wet | 4.99% | T3 | 2 | min | 4000 RPM, | residue, visually black and ICP-MS |
| | | | | | | | additional | | | | | | | 10 min | Sequential dissolves more CRC |
| | | | | | | | | | | | | | | | confirmed additional extraction of |
| | | | | | | | | | | | | | | | REEs |
| 72 | #71R | 0.500 | IL#1 | 10.542 | | | no | | wet | 4.53% | T3 | 2 | min | 4000 RPM, | residue, visually black and ICP-MS |
| | | | | | | | additional | | | | | | | 10 min | Sequential dissolves more CRC |
| | | | | | | | | | | | | | | | confirmed additional extraction of |
| | | | | | | | | | | | | | | | REEs |
| 73 | CRC | 0.100 | IL#1 | 9.908 | | | <125 | μm | wet | 1.00% | T3 | 2 | min | 4000 RPM, | |
| | | | | | | | | | | | | | | 10 min | |
| 74 | CRC | 0.050 | IL#1 | 9.962 | | | <125 | μm | wet | 0.50% | T3 | 2 | min | 4000 RPM, | |
| | | | | | | | | | | | | | | 10 min | |
| 75 | CRC | 0.025 | IL#1 | 9.987 | | | <125 | μm | wet | 0.25% | T3 | 2 | min | 4000 RPM, | |
| | | | | | | | | | | | | | | 10 min | |
| 76 | CRC | 0.010 | IL#1 | 15.015 | | | <125 | μm | wet | 0.07% | T3 | 1 | min | 4000 RPM, | |
| | | | | | | | | | | | | | | 10 min | |
| 77 | CRC | 0.005 | IL#1 | 10.003 | | | <125 | μm | wet | 0.05% | T3 | 2 | min | 4000 RPM, | |
| | | | | | | | | | | | | | | 10 min | |
| 78 | CRC | 0.001 | IL#1 | 10.010 | | | <125 | μm | wet | 0.01% | T3 | 4.5 | min | 4000 RPM, | |
| | | | | | | | | | | | | | | 10 min | |
| 79 | CRC | 0.002 | IL#1 | 10.008 | | | <45 | μm | wet | 0.02% | T3 | 2 | min | 4000 RPM, | lots attached to stir bar after T3 |
| | | | | | | | | | | | | | | 10 min | |
| 80 | FA | 0.003 | IL#1 | 10.027 | | | no sieve, | | wet | 0.03% | T3 | 2 | min | 4000 RPM, | bright yellow ~30 sec T3 |
| | | | | | | | ash | | | | | | | 10 min | |
| 81 | CRC | 0.501 | IL#1 | 10.000 | | | <125 | μm | wet | 4.77% | T3 | 2 | min | 4000 RPM, | |
| | | | | | | | | | | | | | | 10 min | |
| 82 | CRC | 0.008 | IL#1 | 10.022 | | | <125 | μm | wet | 0.08% | T1 | 24 | h | 4000 RPM, | |
| | | | | | | | | | | | | | | 10 min | |
| 83 | CRC | 0.002 | IL#1 | 10.075 | | | <125 | μm | wet | 0.02% | T3 | 2 | min | 4000 RPM, | |
| | | | | | | | | | | | | | | 10 min | |
| 84 | CRC | 0.003 | IL#1 | 10.030 | | | <45 | μm | wet | 0.03% | T3 | 2 | min | 4000 RPM, | |
| | | | | | | | | | | | | | | 10 min | |
| 85 | CRC | 0.501 | IL#1 | 9.506 | | | <125 | μm | wet | 5.01% | T3 | 2 | min | 4000 RPM, | residue exploded when heated at 100 |
| | | | | | | | | | | | | | | 10 min | ° C., washing of the residue |
| 86 | #85 | 0.517 | | | H₂O | 10.317 | | | | 4.77% | | | | | |
| 87 | #85 | | | | acetone | | | | | 1:1 through | | | | | (Acetone Separations) acetone |
| | | | | | | | | | | 1:1000 | | | | | extracts another liquid layer with |
| | | | | | | | | | | | | | | | some going into acetone as well. 1:1 |
| | | | | | | | | | | | | | | | is miscible, but 1:2, 1:3, 1:5, 1:10 |
| | | | | | | | | | | | | | | | result in separations |
| 88 | ASPH | 0.500 | IL#1 | 9.500 | | | ground, | | wet | 5.00% | T3 | 2 | min | 4000 RPM, | |
| | | | | | | | no sieve | | | | | | | 10 min | |
| 89 | CRC | 0.501 | IL#1 | 9.513 | | | <125 | μm | wet | 5.00% | T3 | 10 | min | 4000 RPM, | |
| | | | | | | | | | | | | | | 10 min | |
| 90 | CRC | 0.500 | | | H₂O | 9.515 | <125 | μm | wet | 4.99% | T3 | 2 | min | 4000 RPM, | |
| | | | | | | | | | | | | | | 10 min | |
| 91 | BA | 1.176 | IL#1 | 11.773 | | | big rock | | wet | 9.08% | T3 | 1 | min | 4000 RPM, | bubbled after addition of IL, quite |
| | | | | | | | | | | | | | | 10 min | bright yellow after ~30 sec T3, |
| | | | | | | | | | | | | | | | magnetic particles stuck to stir bar, |
| | | | | | | | | | | | | | | | rock breaking apart with treatment |
| 92 | BA | 1.174 | IL#1 | 11.791 | | | pebble/ash | | wet | 9.06% | T3 | 1 | min | 4000 RPM, | Fibrous looking when stirred, |
| | | | | | | | | | | | | | | 10 min | bubbles in IL, very yellow/green, lots |
| | | | | | | | | | | | | | | | of magnetic particles on stir bar |
| 93 | CKR | 1.443 | IL#1 | 14.456 | | | rock | | wet | 9.08% | T3 | 2 | min | 4000 RPM, | bright yellow ~40 sec, orange after |
| | | | | | | | | | | | | | | 10 min | MW |
| 94 | FA | 0.505 | IL#1 | 9.510 | | | no sieve, | | wet | 5.04% | T3 | 2 | min | 4000 RPM, | very green/yellow, magnetic |
| | | | | | | | ash | | | | | | | 10 min | particulate on stir bar |
| 95 | #94 | 0.527 | | | H₂C | 10.523 | | | | 4.77% | | | | | |
| 96 | #94 | | | | acetone | | | | | | | | | | Acetone or Ethyl acetate separations) |
| | | | | | | | | | | | | | | | Also results in biphasic system, |
| | | | | | | | | | | | | | | | extraction of liquid and cloudy |
| | | | | | | | | | | | | | | | extraction into acetone (Ca, etc.) |
| 97 | #85R | 0.001 | IL#1 | 15.040 | | | no grind | | wet | 0.01% | T3 | 2 | min | 4000 RPM, | |
| | | | | | | | | | | | | | | 10 min | |
| 98 | #97 | 2.010 | | | H₂O | 2.004 | | | | 50.07% | | | | | H₂O addition, immediately hot |
| 99 | #85R | 0.002 | IL#1 | 15 | | | extra grind | | wet | 0.01% | T3 | 2 | min | 4000 RPM, | |
| | | | | | | | | | | | | | | 10 min | |
| 100 | #99 | 2.444 | | | H₂O | 2.423 | | | | 50.22% | | | | | H₂O addition, immediately hot |
| 101 | CARB | 0.100 | IL#1 | 9.922 | | | no grind | | wet | 1.00% | T3 | 2 | min | 4000 RPM, | 10 sec T3 = cloudy white with |
| | | | | | | | | | | | | | | 10 min | magnetic flecks on stir bar, 1 min T3 = |
| | | | | | | | | | | | | | | | deeper opaque yellow, 2 min T3 = |
| | | | | | | | | | | | | | | | deep opaque yellow with a lot of |
| | | | | | | | | | | | | | | | magnetic particulate on stir bar |
| 102 | CRC | 0.010 | IL#1 | 10.179 | | | <125 | μm | wet | 0.10% | T3 | 1 | min | 4000 RPM, | dark ~30 sec T3, consistent with |
| | | | | | | | | | | | | | | 10 min | others |
| 103 | CRC | 0.011 | IL#1 | 15.033 | | | | | | 0.07% | T3 | 1 | min | 4000 RPM, | dark ~30 sec T3, consistent with |
| | | | | | | | | | | | | | | 10 min | others |
| 104 | CRC | 0.011 | IL#1 | 10.009 | | | ground | | wet | 0.11% | T3 | 1 | min | 4000 RPM, | dark ~30 sec of T3, consistent with |
| | | | | | | | with back | | | | | | | 10 min | others, ground on paper, lost some |
| | | | | | | | of spatula | | | | | | | | before weighing |
| 105 | CRC | 0.014 | IL#1 | 10.048 | | | ground | | wet | 0.14% | T3 | 1 | min | 4000 RPM, | dark ~20 sec of T3, a bit faster, |
| | | | | | | | with back | | | | | | | 10 min | ground on glass |
| | | | | | | | of spatula | | | | | | | | |
| 106 | — | — | IL#1 | only | | | | | | | | | | | For ICP-MS |
| 107 | CRC | 0.010 | IL#1 | 10.001 | | | <125 | μm | wet | 0.10% | T3 | 2 | min | 4000 RPM, | |
| | | | | | | | | | | | | | | 10 min | |
| 108 | CRC | 0.050 | IL#1 | 9.957 | | | <125 | μm | wet | 0.50% | T3 | 2 | min | 4000 RPM, | |
| | | | | | | | | | | | | | | 10 min | |
| 109 | CRC | 0.100 | IL#1 | 9.912 | | | <125 | μm | wet | 1.00% | T3 | 2 | min | 4000 RPM, | |
| | | | | | | | | | | | | | | 10 min | |
| 110 | CRC | 0.200 | IL#1 | 9.863 | | | <125 | μm | wet | 1.99% | T3 | 2 | min | 4000 RPM, | |
| | | | | | | | | | | | | | | 10 min | |
| 111 | CLB-1 | 0.100 | IL#1 | 9.928 | | | <125 | μm | wet | 1.00% | T3 | 2 | min | 4000 RPM, | |
| | | | | | | | | | | | | | | 10 min | |
| 112 | CLB-1 | 0.200 | IL#1 | 9.800 | | | <125 | μm | wet | 2.00% | T3 | 2 | min | 4000 RPM, | |
| | | | | | | | | | | | | | | 10 min | |
| 113 | AL-1 | 0.100 | IL#1 | 9.928 | | | <125 | μm | wet | 1.00% | T3 | 2 | min | 4000 RPM, | |
| | | | | | | | | | | | | | | 10 min | |
| 114 | AL-1 | 0.201 | IL#1 | 9.811 | | | <125 | μm | wet | 2.01% | T3 | 2 | min | 4000 RPM, | |
| | | | | | | | | | | | | | | 10 min | |
| 115 | AL-1 | 0.500 | IL#1 | 9.508 | | | <125 | μm | wet | 5.00% | T3 | 2 | min | 4000 RPM, | |
| | | | | | | | | | | | | | | 10 min | |
| 116 | CRC | 0.102 | IL#1 | 8.007 | PEG 200 | 2.008 | <125 | μm | wet | 1.01% | T3 | 2 | min | 4000 RPM, | PEG/IL on 4 h before T3, PEG- |
| | | | | | | | | | | | | | | 10 min | treated appear oiler, extra extraction |
| 117 | CLB-1 | 0.100 | IL#1 | 8.019 | PEG 200 | 2.005 | <125 | μm | wet | 0.99% | T3 | 2 | min | 4000 RPM, | PEG/IL on 4 h before T3, PEG- |
| | | | | | | | | | | | | | | 10 min | treated appear oiler, extra extraction |
| 118 | CRC | 0.103 | IL#1 | 8.020 | PEG 200 | 2.009 | <125 | μm | wet | 1.02% | T3 | 2 | min | 4000 RPM, | PEG/IL on 24 h before T3, PEG- |
| | | | | | | | | | | | | | | 10 min | treated appear oiler, extra extraction |
| 119 | CLB-1 | 0.103 | IL#1 | 8.039 | PEG 200 | 2.012 | <125 | μm | wet | 1.01% | T3 | 2 | min | 4000 RPM, | PEG/IL on 24 h before T3, PEG- |
| | | | | | | | | | | | | | | 10 min | treated appear oiler, extra extraction |
| 120 | CRC | 0.071 | IL#1 | 65.000 | | | | | | 0.11% | T3 | 2 | min | 4000 RPM, | large volume, open top, not much |
| | | | | | | | | | | | | | | 10 min | stirring |
| 121 | NdOAc | 0.585 | IL#1 | 17.429 | | | | | | 3.25% | T2 | 1 | h | | In solution at T2, but falls out at RT, |
| | | | | | | | | | | | | | | | crystalizes, likely NdOAc |
| 122 | #120 | 1.004 | | | H₂O | 10.057 | no sieve, | | wet | 9.08% | | | | 4000 RPM, | |
| | | | | | | | ash | | | | | | | 10 min | |
| 123 | #120 | 2.886 | | | H₂O | 27.123 | | | | 9.62% | | | | | |
| 124 | FA | 0.010 | IL#1 | 10.011 | | | no sieve, | | wet | 0.10% | T3 | 2 | min | 4000 RPM, | bright yellow ~1.5 min |
| | | | | | | | ash | | | | | | | 10 min | |
| 125 | #107 | 1.023 | | | H₂O | 25.062 | | | | 3.92% | — | — | | — | |
| 126 | CRC | 0.100 | IL#1 | 8.909 | IL#8 | 0.819 | <125 | μm | wet | 1.02% | T3 | 2 | min | 4000 RPM, | |
| | | | | | | | | | | | | | | 10 min | |
| 127 | #57 | 0.509 | | | H₂O | 9.664 | | | | 5.00% | | | | | |
| 128 | #57 | 0.521 | | | H₂O | 44.541 | | | | 1.16% | | | | | |
| 129 | #57 | 0.076 | | | H₂O | 45.323 | | | | 0.17% | | | | | |
| 130 | #120 | 2.025 | | | Acetic Acid | 2.045 | | | | 49.75% | | | | | 0.1% Coal:IL + Acetic Acid, heat, |
| | | | | | | | | | | | | | | | bubbles, no precipitation, does not |
| | | | | | | | | | | | | | | | stick to side, residue after spin |
| 131 | #66 | 0.543 | | | Acetic Acid | 0.581 | | | | 48.31% | | | | | 5% Coal:IL + Acetic Acid, hot, dark, |
| | | | | | | | | | | | | | | | viscous, liquid + oily, no |
| | | | | | | | | | | | | | | | precipitation, residue after spin |
| 132 | #120 | 2.033 | | | HNO₃ | 2.048 | | | | 49.82% | | | | | 0.1% Coal:IL + HNO₃, mixed |
| | | | | | | | | | | | | | | | immediately, very hot, 2 layers, dark |
| | | | | | | | | | | | | | | | top, light bottom, no precipitation, |
| | | | | | | | | | | | | | | | residue after spin |
| 133 | #66 | 1.017 | | | HNO₃ | 1.085 | | | | 48.38% | | | | | 5% Coal:IL + HNO₃, hot |
| | | | | | | | | | | | | | | | immediately, bubbles, lots of bubbles |
| | | | | | | | | | | | | | | | and not viscous, still sticks to side, |
| | | | | | | | | | | | | | | | residue after spin |
| 134 | #94 | 0.517 | | | Acetic Acid | 0.544 | | | | 48.73% | | | | | FA + Acetic Acid, hot, Solidified and |
| | | | | | | | | | | | | | | | turned into gel, reliquifid after 48 h, |
| | | | | | | | | | | | | | | | residue after spin |
| 135 | #94 | 0.580 | | | HNO₃ | 0.6 | | | | 49.15% | | | | | FA + HNO₃, not viscous, solid grey |
| | | | | | | | | | | | | | | | precipitate, residue after spin |
| 136 | | | IL#1 | | Acetic Acid | | | | | | | | | | IL + Acetic Acid |
| 137 | CRC | 0.011 | IL#1 | 4.835 | Acetic Acid | 4.817 | <125 | μm | wet | 0.11% | T3 | 2 | min | 4000 RPM, | CRC-AA bubbles |
| | | | | | | | | | | | | | | 10 min | |
| 138 | FA | 0.011 | IL#1 | 4.854 | Acetic Acid | 4.836 | <125 | μm | wet | 0.11% | T3 | 2 | min | 4000 RPM, | sank, no bubbles |
| | | | | | | | | | | | | | | 10 min | |
| 139 | CRC | 0.011 | IL#1 | | Acetic Acid | 9.906 | <125 | μm | wet | 0.11% | T3 | 2 | min | 4000 RPM, | CRC-AA bubbles |
| | | | | | | | | | | | | | | 10 min | |
| 140 | FA | 0.011 | IL#1 | | Acetic Acid | 9.927 | <125 | μm | wet | 0.11% | T3 | 2 | min | 4000 RPM, | sank, no bubbles |
| | | | | | | | | | | | | | | 10 min | |
| 141 | #136 | 0.502 | | | Ethyl Acetate | 0.502 | | | | 50.00% | | | | | |
| 142 | #130 | 0.536 | | | Ethyl Acetate | 0.548 | | | | 49.45% | | | | | no precipitate |
| 143 | #131 | 0.514 | | | Ethyl Acetate | 0.56 | | | | 47.86% | | | | | brown liquid and black precipitate |
| 144 | #134 | 0.132 | | | Ethyl Acetate | 1.183 | | | | 10.04% | | | | | Rehydrated Gel and white precipitate |
| 145 | | | IL#1 | | | | | | | #DIV/0! | | | | | |
| 146 | CRC | 0.500 | IL#1 | 9.672 | | | | | | 4.92% | T3 | 2 | min | 4000 RPM, | |
| | | | | | | | | | | | | | | 10 min | |
| 147 | CRC | 1.004 | IL#1 | 9.034 | | | | | | 10.00% | T3 | 2 | min | 4000 RPM, | 10% more viscous and dark than 5% |
| | | | | | | | | | | | | | | 10 min | |
| 148 | CRC | | IL#1 | | PEG 600 | | <125 | μm | wet | | | | | | |
| 149 | CRC | 0.500 | IL#9 | 9.500 | | | <125 | μm | wet | 5.00% | T2 | 24 | h | 4000 RPM, | |
| | | | | | | | | | | | | | | 10 min | |
| 150 | CRC | 0.500 | IL#9 | 9.500 | | | <125 | μm | wet | 5.00% | T3 | 2 | min | 4000 RPM, | |
| | | | | | | | | | | | | | | 10 min | |
| 151 | NdOAc | | IL#1 | | | | no grind | | wet | 2 mM- | | | | | Multiple trials dissolving 151-156 |
| | | | | | | | | | | 1 wt. % | | | | | and combinations of 151-156 in |
| | | | | | | | | | | | | | | | IL#1. 10-20 mM stayed in solution |
| | | | | | | | | | | | | | | | indefinitely, while the 1 wt. % |
| | | | | | | | | | | | | | | | solution crystallizes out likely into |
| | | | | | | | | | | | | | | | the REE-OAc form. We have shown |
| | | | | | | | | | | | | | | | this form via single crystal XRD. |
| 152 | NdCl | | IL#1 | | | | no grind | | wet | 2 mM- | | | | | See 151 |
| | | | | | | | | | | 1 wt. % | | | | | |
| 153 | YOAc | | IL#1 | | | | no grind | | wet | 2 mM- | | | | | See 151 |
| | | | | | | | | | | 1 wt. % | | | | | |
| 154 | YCl | | IL#1 | | | | no grind | | wet | 2 mM- | | | | | See 151 |
| | | | | | | | | | | 1 wt. % | | | | | |
| 155 | CeCl | | IL#1 | | | | no grind | | wet | 2 mM- | | | | | See 151 |
| | | | | | | | | | | 1 wt. % | | | | | |
| 156 | CeOAc | | IL#1 | | | | no grind | | wet | 2 mM- | | | | | See 151 |
| | | | | | | | | | | 1 wt. % | | | | | |
| 157 | NdHyd | | IL#1 | | | | no grind | | wet | 2 mM- | | | | | |
| | | | | | | | | | | 1 wt. % | | | | | |
| 158 | EuOₓ | | IL#1 | | | | no grind | | wet | 2 mM- | | | | | |
| | | | | | | | | | | 1 wt. % | | | | | |
| 159 | CRC | | | | | | | | | | | | | | CRC only for ICP-MS |
| 160 | #29 | | | | H₂O | 47.5 | | | | | | | | | Water wash of #29 residue |
| 161 | #30 | | | | H₂O | 47.5 | | | | | | | | | Water wash of #30 residue |
| 162 | CRC | | IL#10 | | | | | | | | | | | | Multiple TEAL-based ILs were |
| | | | | | | | | | | | | | | | tested in non-stoichiometric ratios |

### Example 3

### Reference Table of Tested ILs With Reference Numbers

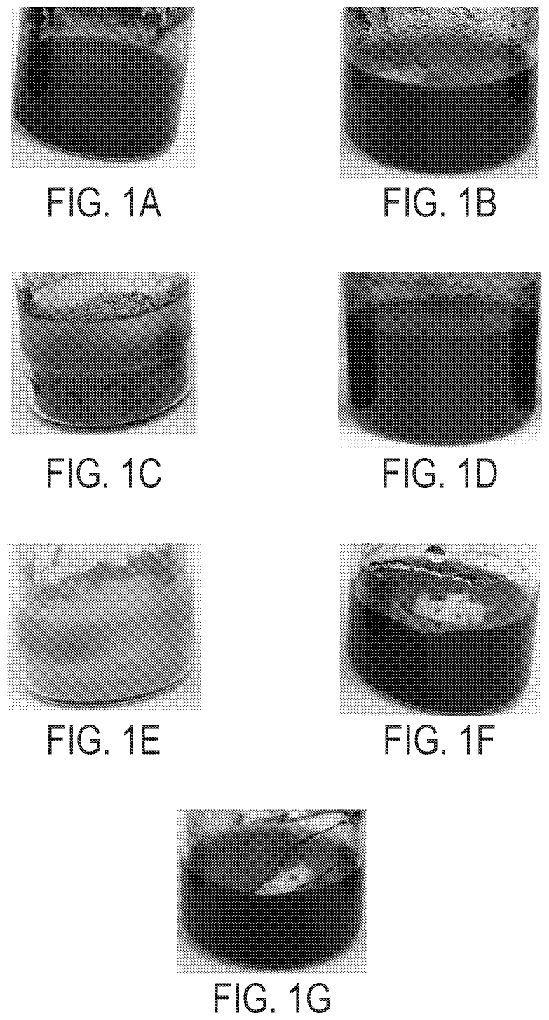

Many ILs were designed and investigated for suitability in the proposed extraction process. See Table 2. All ILs exhibited some degree of coal dissolution. The basic, coordinating IL #1, 1-ethyl-3-methylimidazolium acetate, performed better than the acidic ILs. This is surprising due to the ubiquitous use of acids for REE-leaching and extraction systems. As such, many of the described experiments herein utilize IL #1. See FIGS. 1A-1G.

TABLE 2
Ionic Liquids Used in Described Examples.

| Reference | | |
|---|---|---|
| Number | IL Name | Properties |
| IL#1 | [C₂mim][OAc] | Basic, Coordinating |
| IL#2 | [C₂mim][HCl₂] | Acidic, Coordinating |
| IL#3 | MimSO₃ | Neutral, Acidic |
| IL#4 | [HN₂₂₂][Al₂Cl₇] | Protic, Lewis Acidic, Catalytic |
| IL#5 | SO₃—C₄mim | Neutral, Acidic |
| IL#6 | [MimSO₃H][HSO₄] | Protic, Acidic, Coordinating |
| IL#7 | [MimSO₃H]Cl | Protic, Acidic, Coordinating |
| IL#8 | [Cho][OAc] | Basic |
| IL#9 | [NH₄][C₂O₄] | Used in REE mining |
| IL#10 | TEAL-based ILs | Protic, Lewis Acidic, Catalytic |

### Example 4

### Process for Extraction and Recovery of REEs From Coal

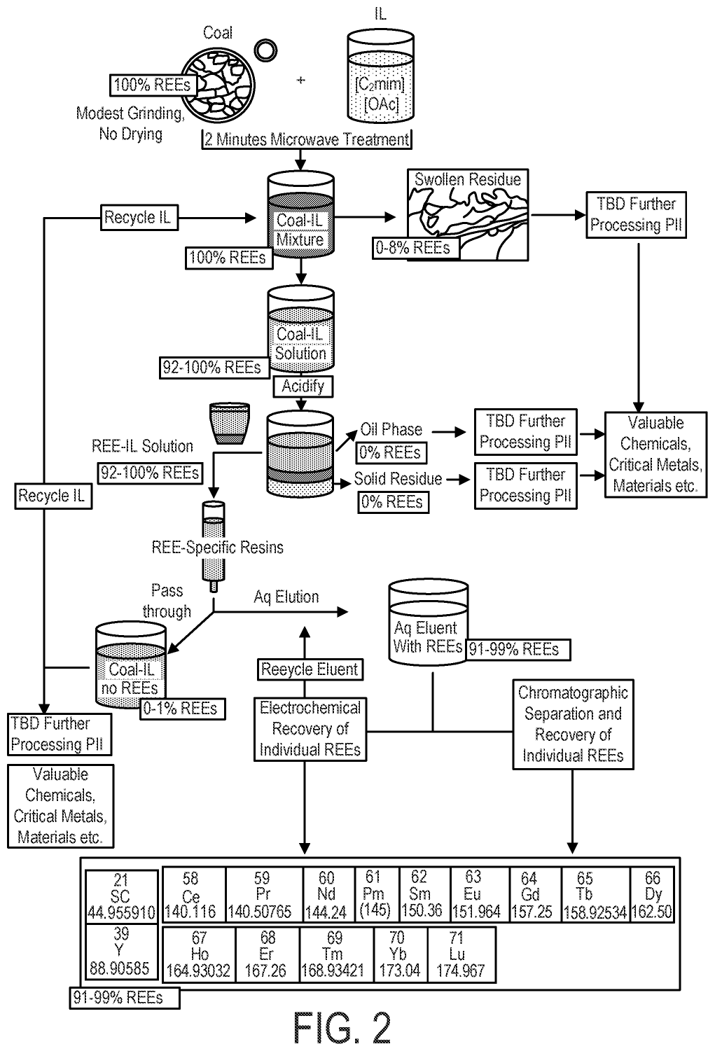

This process was developed and demonstrated for the extraction and recovery of REEs from coal. Extraction: (1) Light grinding of wet coal then 2 min T3 with IL #1; (2) spin to remove residue and obtain dissolved coal/IL solutions with extracted REEs, Isolation; (3) acidification of solution results in REE/IL-containing liquid, oily fraction, and solid particulate; (4) concentration of REEs into aqueous eluent was demonstrated using typical commercial resins; (5) recovery of solid REEs was developed via electrochemical methods or chromatographic separations to recover mixed or individual REE solids. See FIG. 2.

### Example 5

### P&ID Drawings of Extraction and Recovery Process

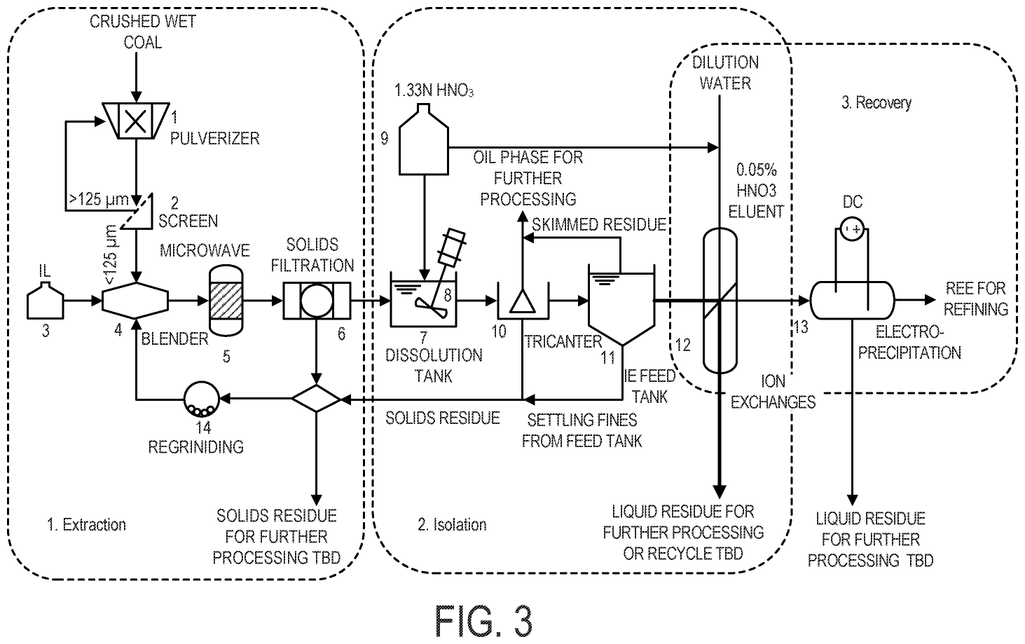

This example demonstrates an engineered process that used ILs, microwave processing, and electrochemical methods for the extraction and recovery of REEs, including streams for production of co-products. See FIG. 3.

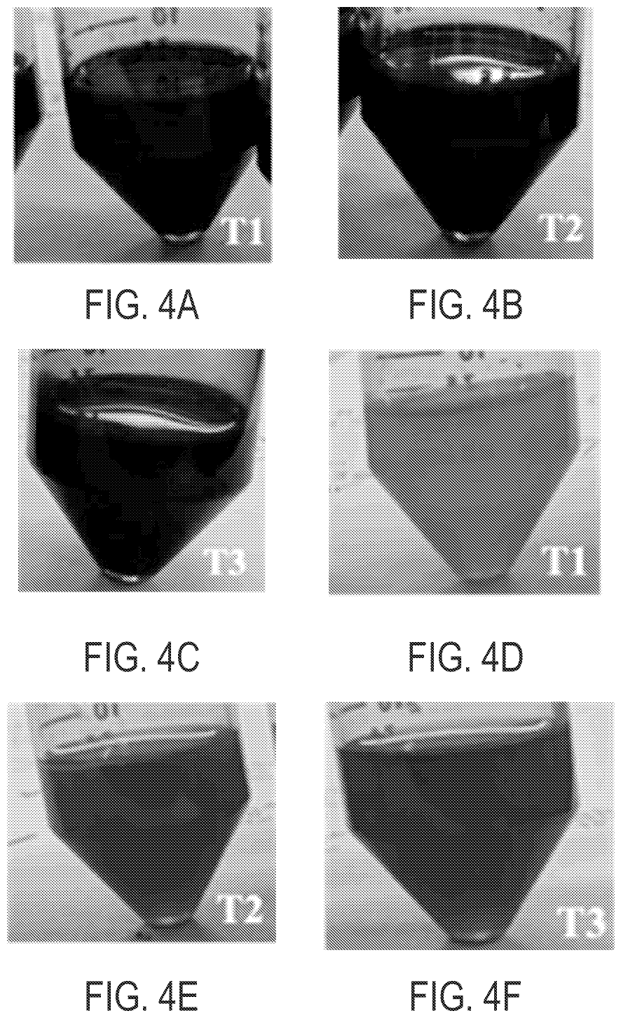

CRC was dissolved in IL #1 (5 wt. %) at room temperature for 24 hours (T1, Experiment #28), thermal heating for 24 hours (T2, Experiment #29), or microwave treatment for 2 minutes (T3, Experiment #30) as described in Table 1. FA was dissolved in IL #1 (5 wt. %) at room temperature for 24 hours (T1, Experiment #34), thermal heating for 24 hours (T2, Experiment #36), or microwave treatment for 2 minutes (T3, Experiment #35) as described in Table 1. Source/IL solutions were isolated via centrifugation. See FIGS. 4A-4F.

### Example 6

### Calculating REEs Extracted and Present in Process

ICP-MS was performed to calculate the REEs extracted and present in various steps in the process, including the source/IL solutions. Percentage of REEs extracted from various samples and treatments in the source/IL is given below by experimental number. Sources that had an unknown REE-concentration could not be evaluated for total REE % extracted. Some error is present based on natural sample variation.

TABLE 3

| | | | | | % REE |
|---|---|---|---|---|---|
| | % REE | Experiment | % REE | Experiment | extracted, |
| Ex No | extracted, | Number | extracted, | Number | FA/IL |
| (Table 1) | CRC solution | (Table 1) | CRC solution | (Table 1) | solution |
| 1 | 1.80% | 67 | 2.52% | 11 | 0.27% |
| 8 | 2.76% | 68 | 3.06% | 34 | 0.73% |
| 13 | 0.68% | 69 | 2.90% | 35 | 0.80% |
| 16 | 1.91% | 70 | 1.96% | 36 | 1.13% |
| 20 | 0.57% | 71 | 1.54% | 37 | 0.42% |
| 27 | 6.76% | 72 | 1.43% | 56 | 0.01% |
| 28 | 1.00% | 75 | 39.61% | 80 | 11.35% |
| 29 | 2.09% | 77 | 104.01% | 94 | 3.15% |
| 30 | 2.37% | 78 | 121.81% | 138 | 20.64% |
| 31 | 4.29% | 79 | 73.48% | 140 | 4.58% |
| 33 | 9.67% | 83 | 87.91% | | |
| 38 | 1.59% | 84 | 77.65% | | |
| 51 | 1.30% | 85 | 6.03% | | |
| 53 | 0.20% | 89 | 2.34% | | |
| 57 | 1.06% | 90 | 0.84% | | |
| 58 | 0.69% | 107 | 91.45% | | |
| 59 | 0.47% | 108 | 33.45% | | |
| 60 | 0.44% | 109 | 12.50% | | |
| 61 | 1.25% | 110 | 6.22% | | |
| 62 | 0.98% | 116 | 2.86% | | |
| 63 | 0.64% | 118 | 39.71% | | |
| 64 | 0.11% | 126 | 3.21% | | |
| 65 | 0.34% | 137 | 44.01% | | |
| 66 | 16.07% | 139 | 10.89% | | |

| | % REE |
|---|---|
| Experiment | extracted, |
| Number | CARB/IL |
| (Table 1) | solution |
| 101 | 2.06% |

### Example 7

### Extraction of REEs Into Solution

Extraction of REEs into source/IL solutions was observed via ICP-MS. Raw individual REE concentrations in solution for various experiments is given by experimental number in Table 4 (Parts 1, 2, 3) below. Selected examples of REEs extracted into solution based on starting source mass are given in Table 5, in ppm.

TABLE 4
Part 1. Raw REEs in solution (ppb).

| Ex | Sc | Y | La | Ce | Pr | Nd | Sm | Eu | Gd |
|---|---|---|---|---|---|---|---|---|---|
| No | 45 | 89 | 139 | 140 | 141 | 142 | 152 | 153 | 158 |
| 53 | 3.673 | 0.185 | 1.222 | 1.991 | 0.199 | 0.680 | 0.101 | 0.000 | 0.085 |
| 30 | 56.593 | 5.614 | 8.200 | 8.119 | 0.798 | 3.439 | 12.591 | 18.782 | 0.773 |
| 32 | 58.058 | 5.968 | 5.383 | 7.689 | 0.626 | 2.874 | 8.304 | 9.588 | 0.683 |
| 55 | 0.342 | 0.100 | 0.016 | 0.035 | 0.005 | 0.009 | 0.097 | 0.037 | 0.002 |
| 35 | 68.885 | 35.435 | 36.365 | 43.537 | 7.248 | 26.756 | 5.287 | 2.251 | 5.477 |
| 27 | 58.828 | 4.059 | 2.329 | 3.542 | 0.469 | 2.256 | 2.917 | 138.796 | 0.624 |
| 37 | 33.762 | 14.555 | 17.937 | 22.278 | 3.951 | 15.286 | 3.490 | 1.829 | 2.835 |
| 54 | 17.290 | 5.631 | 29.899 | 56.058 | 6.201 | 21.930 | 3.177 | 0.666 | 2.739 |
| 28 | 56.541 | 4.695 | 3.149 | 2.781 | 0.464 | 2.254 | 5.388 | 201.668 | 0.555 |
| 33 | 45.263 | 3.160 | 0.988 | 15.253 | 0.264 | 1.663 | 1.019 | 1.764 | 0.883 |
| 56 | 2.799 | 0.221 | 0.074 | 0.113 | 0.009 | 0.001 | 1.097 | 0.731 | 0.002 |
| 36 | 88.308 | 34.827 | 29.571 | 33.365 | 6.669 | 28.564 | 6.590 | 3.243 | 4.871 |
| 29 | 74.403 | 12.492 | 10.019 | 10.875 | 1.904 | 8.420 | 6.944 | 4.817 | 1.678 |
| 51 | 72.333 | 6.059 | 5.385 | 5.151 | 0.589 | 2.821 | 8.143 | 5.597 | 0.785 |
| 31 | 61.886 | 5.056 | 4.676 | 7.855 | 0.608 | 2.877 | 6.932 | 71.852 | 0.768 |
| 38 | 68.593 | 14.712 | 14.155 | 19.771 | 2.589 | 10.158 | 8.590 | 5.353 | 2.047 |
| 34 | 61.732 | 54.296 | 48.811 | 60.544 | 10.869 | 40.190 | 6.757 | 2.620 | 8.183 |
| 14 | 64.164 | 1.600 | 1.824 | 1.682 | 0.266 | 1.530 | 18.735 | 14.173 | 1.744 |
| 13 | 52.788 | 1.581 | 1.344 | 1.755 | 0.255 | 1.306 | 5.383 | 3.899 | 0.998 |
| 16 | 12.142 | 2.748 | 4.190 | 4.185 | 0.592 | 1.936 | 0.374 | 0.211 | 0.436 |
| 20 | 40.201 | 6.232 | 11.700 | 7.940 | 1.217 | 4.095 | 9.132 | 7.088 | 0.750 |
| 39 | 23.181 | 0.056 | 0.034 | 0.045 | 0.005 | 0.025 | 0.168 | 0.084 | 0.010 |
| 40 | 24.254 | 0.088 | 0.080 | 0.061 | 0.008 | 0.046 | 0.428 | 0.266 | 0.013 |
| 41 | 24.283 | 0.177 | 0.149 | 0.118 | 0.014 | 0.077 | 0.856 | 0.557 | 0.027 |
| 42 | 24.454 | 0.197 | 0.218 | 0.183 | 0.019 | 0.089 | 1.038 | 0.706 | 0.024 |
| 43 | 23.129 | 0.166 | 0.142 | 0.203 | 0.017 | 0.093 | 0.589 | 0.377 | 0.025 |
| 44 | 22.789 | 0.222 | 0.191 | 0.213 | 0.023 | 0.109 | 0.807 | 0.559 | 0.031 |
| 45 | 22.946 | 0.051 | 0.021 | 0.204 | 0.004 | 0.024 | 0.051 | 0.010 | 0.014 |
| 46 | 22.402 | 16.805 | 14.056 | 17.307 | 3.383 | 13.789 | 2.687 | 0.702 | 2.830 |
| 47 | 21.650 | 16.302 | 15.366 | 18.292 | 3.570 | 14.977 | 2.805 | 0.693 | 3.012 |
| 48 | 23.863 | 4.677 | 4.853 | 5.789 | 1.124 | 4.759 | 1.154 | 0.422 | 0.875 |
| 49 | 24.345 | 4.624 | 5.448 | 6.823 | 1.239 | 4.842 | 1.265 | 0.474 | 0.899 |
| 50 | 23.619 | 0.418 | 0.346 | 0.524 | 0.069 | 0.284 | 0.727 | 0.464 | 0.068 |
| 51 | 24.515 | 0.375 | 0.373 | 0.419 | 0.058 | 0.243 | 1.024 | 0.663 | 0.058 |

Part 2 (ppb).

| Ex | Tb | Dy | Ho | Er | Tm | Yb | Lu | U |
|---|---|---|---|---|---|---|---|---|
| No | 159 | 164 | 165 | 166 | 169 | 174 | 175 | 238 |
| 53 | 0.009 | 0.039 | 0.008 | 0.021 | 0.003 | 0.020 | 0.003 | 0.042 |
| 30 | 0.052 | 0.244 | 0.028 | 0.082 | 0.019 | 0.046 | 0.006 | 0.111 |
| 32 | 0.048 | 0.239 | 0.035 | 0.087 | 0.013 | 0.060 | 0.011 | 0.198 |
| 55 | 0.000 | 0.000 | 0.000 | 0.000 | 0.000 | 0.000 | 0.000 | 0.000 |
| 35 | 0.523 | 2.464 | 0.475 | 1.454 | 0.201 | 1.406 | 0.221 | 36.629 |
| 27 | 0.054 | 0.228 | 0.037 | 0.095 | 0.165 | 0.063 | 0.008 | 0.283 |
| 37 | 0.254 | 1.161 | 0.215 | 0.622 | 0.076 | 0.489 | 0.069 | 6.227 |
| 54 | 0.269 | 1.298 | 0.214 | 0.544 | 0.062 | 0.387 | 0.054 | 0.853 |
| 28 | 0.051 | 0.219 | 0.037 | 0.088 | 0.221 | 0.054 | 0.008 | 0.209 |
| 33 | 0.055 | 0.242 | 0.045 | 0.118 | 0.015 | 0.084 | 0.011 | 0.450 |
| 56 | 0.000 | 0.000 | 0.000 | 0.000 | 0.000 | 0.001 | 0.000 | 0.016 |
| 36 | 0.606 | 3.344 | 0.618 | 1.790 | 0.246 | 1.525 | 0.232 | 12.390 |
| 29 | 0.181 | 0.962 | 0.169 | 0.482 | 0.061 | 0.381 | 0.055 | 2.568 |
| 51 | 0.063 | 0.338 | 0.045 | 0.111 | 0.012 | 0.064 | 0.011 | 0.131 |
| 31 | 0.050 | 0.231 | 0.036 | 0.093 | 0.095 | 0.058 | 0.009 | 0.225 |
| 38 | 0.172 | 0.792 | 0.133 | 0.390 | 0.045 | 0.291 | 0.043 | 2.841 |
| 34 | 0.808 | 3.877 | 0.763 | 2.291 | 0.301 | 2.158 | 0.321 | 27.648 |
| 14 | 0.083 | 0.190 | 0.027 | 0.133 | 0.014 | 0.072 | 0.014 | 0.057 |
| 13 | 0.052 | 0.152 | 0.022 | 0.085 | 0.009 | 0.061 | 0.008 | 0.063 |
| 16 | 0.048 | 0.264 | 0.057 | 0.171 | 0.027 | 0.171 | 0.026 | 1.750 |
| 20 | 0.066 | 0.377 | 0.058 | 0.167 | 0.024 | 0.151 | 0.026 | 1.660 |
| 39 | 0.001 | 0.005 | 0.001 | 0.001 | 0.000 | 0.001 | 0.000 | 0.004 |
| 40 | 0.001 | 0.006 | 0.001 | 0.002 | 0.001 | 0.002 | 0.000 | 0.003 |
| 41 | 0.002 | 0.011 | 0.002 | 0.004 | 0.000 | 0.002 | 0.000 | 0.002 |
| 42 | 0.002 | 0.010 | 0.002 | 0.004 | 0.001 | 0.003 | 0.001 | 0.003 |
| 43 | 0.002 | 0.012 | 0.002 | 0.005 | 0.000 | 0.003 | 0.001 | 0.005 |
| 44 | 0.003 | 0.015 | 0.003 | 0.006 | 0.001 | 0.005 | 0.001 | 0.007 |
| 45 | 0.001 | 0.006 | 0.001 | 0.003 | 0.000 | 0.002 | 0.000 | 0.021 |
| 46 | 0.335 | 1.836 | 0.354 | 0.954 | 0.119 | 0.744 | 0.119 | 6.882 |
| 47 | 0.347 | 1.828 | 0.336 | 0.882 | 0.102 | 0.590 | 0.096 | 8.218 |
| 48 | 0.102 | 0.581 | 0.106 | 0.299 | 0.037 | 0.227 | 0.036 | 1.853 |
| 49 | 0.102 | 0.565 | 0.103 | 0.273 | 0.036 | 0.208 | 0.031 | 1.660 |
| 50 | 0.007 | 0.042 | 0.007 | 0.019 | 0.002 | 0.016 | 0.002 | 0.133 |
| 51 | 0.006 | 0.032 | 0.005 | 0.014 | 0.002 | 0.011 | 0.002 | 0.043 |

Part 3 (ppb)

| Ex | | | | | | | | | | | | | | | | |
|---|---|---|---|---|---|---|---|---|---|---|---|---|---|---|---|---|
| No | Y | La | Ce | Pr | Nd | Eu | Sm | Gd | Tb | Dy | Ho | Er | Tm | Yb | Lu | U |
| 107 | 2.15 | 0.79 | 1.83 | 0.19 | 26.85 | 0.26 | 0.41 | 2.99 | 1.35 | 2.07 | 0.06 | 1.89 | 0.02 | 0.11 | 0.02 | 0.36 |
| 108 | 4.40 | 2.82 | 5.13 | 0.55 | 54.76 | 0.55 | 1.31 | 2.99 | 0.45 | 1.00 | 0.09 | 0.72 | 0.03 | 0.15 | 0.02 | 0.26 |
| 109 | 6.44 | 5.87 | 9.61 | 0.98 | 25.84 | 0.93 | 2.30 | 1.94 | 0.28 | 0.91 | 0.13 | 0.53 | 0.04 | 0.21 | 0.04 | 0.41 |
| 110 | 7.47 | 8.37 | 12.65 | 1.23 | 16.55 | 1.43 | 3.70 | 1.84 | 0.25 | 0.94 | 0.15 | 0.51 | 0.05 | 0.25 | 0.04 | 0.53 |
| 111 | 6.19 | 2.73 | 7.85 | 0.78 | 8.39 | 0.44 | 1.19 | 1.20 | 0.24 | 1.17 | 0.20 | 0.55 | 0.07 | 0.34 | 0.06 | 0.74 |
| 112 | 12.64 | 5.58 | 17.25 | 1.82 | 8.37 | 0.77 | 2.46 | 2.49 | 0.54 | 2.65 | 0.47 | 1.18 | 0.15 | 0.75 | 0.12 | 1.36 |
| 113 | 4.63 | 1.55 | 4.43 | 0.38 | 2.65 | 0.24 | 0.51 | 0.55 | 0.12 | 0.64 | 0.13 | 0.35 | 0.04 | 0.22 | 0.04 | 0.51 |
| 114 | 9.18 | 2.7 | 7.27 | 0.70 | 3.91 | 0.32 | 0.78 | 0.89 | 0.20 | 1.15 | 0.24 | 0.67 | 0.08 | 0.41 | 0.07 | 0.91 |
| 115 | 18.96 | 5.80 | 14.62 | 1.44 | 20.50 | 0.56 | 1.68 | 2.07 | 0.45 | 2.53 | 0.53 | 1.47 | 0.18 | 0.92 | 0.15 | 1.94 |
| 126 | 1.50 | 2.30 | 3.09 | 0.25 | 5.42 | 0.39 | 0.95 | 0.28 | 0.04 | 0.20 | 0.04 | 0.10 | 0.01 | 0.05 | 0.01 | 0.23 |
| 116 | 1.47 | 1.86 | 2.47 | 0.23 | 4.98 | 0.37 | 0.81 | 0.25 | 0.04 | 0.21 | 0.04 | 0.11 | 0.01 | 0.06 | 0.01 | 0.33 |
| 117 | 5.84 | 2.86 | 9.14 | 0.91 | 3.98 | 0.43 | 1.28 | 1.19 | 0.25 | 1.24 | 0.21 | 0.54 | 0.07 | 0.34 | 0.05 | 1.04 |
| 118 | 2.08 | 2.26 | 3.63 | 2.12 | 3.31 | 0.54 | 0.88 | 103.96 | 16.24 | 23.79 | 0.15 | 22.04 | 0.02 | 0.08 | 0.02 | 0.29 |
| 119 | 5.43 | 2.71 | 8.24 | 0.96 | 2.28 | 0.42 | 1.25 | 9.06 | 1.47 | 2.93 | 0.20 | 2.23 | 0.06 | 0.30 | 0.05 | 0.90 |
| 124 | 2.02 | 4.54 | 8.41 | 0.76 | 22.06 | 0.31 | 0.69 | 0.61 | 0.10 | 0.38 | 0.07 | 0.23 | 0.02 | 0.13 | 0.02 | 1.63 |
| 122 | 0.05 | 0.05 | 0.15 | 0.01 | 8.71 | 0.02 | 0.02 | 0.08 | 0.01 | 0.03 | 0.00 | 0.02 | 0.00 | 0.00 | 0.00 | 0.04 |
| 123 | 0.03 | 0.03 | 0.09 | 0.01 | 6.19 | 0.00 | 0.01 | 0.07 | 0.01 | 0.02 | 0.00 | 0.02 | 0.00 | 0.00 | 0.00 | 0.03 |
| 120 | 1.31 | 0.42 | 1.37 | 0.09 | 1.07 | 0.16 | 0.23 | 0.13 | 0.03 | 0.14 | 0.03 | 0.07 | 0.01 | 0.05 | 0.01 | 0.61 |
| 129 | 0.02 | 0.08 | 0.12 | 0.01 | 0.54 | 0.00 | 0.01 | 0.01 | 0.00 | 0.00 | 0.00 | 0.00 | 0.00 | 0.00 | 0.00 | 0.00 |
| 128 | 0.12 | 0.19 | 0.33 | 0.03 | 0.35 | 0.01 | 0.03 | 0.02 | 0.00 | 0.02 | 0.00 | 0.01 | 0.00 | 0.01 | 0.00 | 0.05 |
| 127 | 0.14 | 0.44 | 0.73 | 0.06 | 0.95 | 0.03 | 0.09 | 0.04 | 0.01 | 0.03 | 0.01 | 0.02 | 0.00 | 0.01 | 0.00 | 0.03 |

TABLE 5
REEs in solution calculated for starting source mass (ppm).

| Sam- | Wt. | | | | | | | | | | | | | | | | | |
|---|---|---|---|---|---|---|---|---|---|---|---|---|---|---|---|---|---|---|
| ple | % | Sc | Y | La | Ce | Pr | Nd | Eu | Sm | Gd | Tb | Dy | Ho | Er | Tm | Yb | Lu | U |
| CRC/ | 0.01 | * | 8.961 | 7.482 | 12.766 | 1.462 | 14.414 | 3.792 | 2.351 | 1.839 | 0.230 | 1.120 | 0.203 | 0.566 | 0.078 | 0.393 | 0.067 | 0.355 |
| IL#1 | wt. % | | | | | | | | | | | | | | | | | |
| CRC/ | 0.05 | * | 6.683 | 6.215 | 10.276 | 1.114 | 21.130 | 0.485 | 1.199 | 1.542 | 0.173 | 0.808 | 0.140 | 0.413 | 0.043 | 0.267 | 0.036 | 0.173 |
| IL#1 | wt. % | | | | | | | | | | | | | | | | | |
| CRC/ | 0.25 | * | 2.101 | 3.522 | 5.791 | 0.590 | 3.591 | 0.189 | 0.666 | 0.573 | 0.060 | 0.302 | 0.054 | 0.146 | 0.017 | 0.098 | 0.013 | 0.061 |
| IL#1 | wt. % | | | | | | | | | | | | | | | | | |
| CRC/ | 5.0 | * | 0.401 | 0.502 | 0.675 | 0.103 | 0.427 | 0.062 | 0.181 | 0.097 | 0.012 | 0.063 | 0.012 | 0.035 | 0.005 | 0.028 | 0.004 | 0.095 |
| IL#1 | wt. % | | | | | | | | | | | | | | | | | |
| FA/ | 0.1 | * | 4.746 | 6.537 | 11.197 | 1.397 | 7.280 | 0.449 | 1.712 | 1.137 | 0.141 | 0.785 | 0.151 | 0.445 | 0.057 | 0.378 | 0.055 | 1.381 |
| IL#1 | wt. % | | | | | | | | | | | | | | | | | |
| BA/ | 5.0 | * | 5.288 | 7.304 | 13.505 | 1.454 | 5.796 | 0.387 | 1.361 | 1.391 | 0.149 | 0.738 | 0.139 | 0.376 | 0.040 | 0.244 | 0.038 | 5.883 |
| IL#1 | wt. % | | | | | | | | | | | | | | | | | |
| CARB/ | 1.0 | 1.769 | 7.005 | 0.250 | 0.257 | 6.541 | 46.120 | 0.644 | 2.288 | 2.870 | 0.201 | 0.901 | 0.165 | 0.523 | 0.070 | 0.455 | 0.073 | 0.074 |
| IL#1 | wt. % | | | | | | | | | | | | | | | | | |

### Example 8

### Extraction of Additional Metals Into Solution

Extraction of additional metals into Source/IL solutions was confirmed via ICP-MS. Raw ICP-MS concentration data in various solutions given by experimental number. Table 6, (Part 1-3). ICP-MS confirmed extraction of Li, Be, Mg, Al, Ca, V, Cr, Mn, Fe, Co, Ni, Cu, Zn, Ga, As, Se, Rb, Ag, Cd, Cs, Ba, Hg, Tl, Pb, Bi, and U in addition to the REEs. ICP-OES also confirmed the presence of Sr, Zr, and B in addition to the elements listed above. *Asterisk indicates measurable levels, but instrumental inaccuracies.

TABLE 6
Part 1. Raw Metals in Solution (ppb).

| Ex | sample | Li | Be | Mg | Al | K | Ca | V |
|---|---|---|---|---|---|---|---|---|
| No | volume mL | 7 | 9 | 24 | 27 | 39 | 43 | 51 |
| 159 | 1 | 1.207 | 0.176 | 2.030 | 0.163 | 13.288 | 26104.118 | 14.223 |
| 14 | 10 | 30.950 | 0.030 | 23.848 | 34.778 | * | 1405.424 | 15.778 |
| 13 | 10 | 11.034 | 0.039 | 1.764 | 72.141 | * | 18509.919 | 12.240 |
| 8 | 10 | 1.999 | 0.000 | 57.051 | 89.859 | * | 5216.974 | 4.633 |
| 20 | 10 | 7.519 | 0.080 | * | * | 28.246 | 38046.184 | 37.119 |
| 27 | 10 | 5.333 | 0.041 | * | 181.224 | * | * | 16.167 |
| 28 | 10 | 6.957 | 0.072 | * | 113.936 | * | * | 76.451 |
| 30 | 10 | 14.988 | 0.015 | * | 149.195 | * | * | 104.385 |
| 16 | 10 | 2.153 | 0.046 | * | * | * | 131568.720 | 23.633 |
| 33 | 10 | 1.466 | 0.000 | * | 15.749 | 30.454 | 33934.433 | 4.080 |
| 31 | 10 | 10.554 | 0.048 | * | 165.249 | * | * | 56.874 |
| 32 | 10 | 15.662 | 0.065 | * | 148.374 | * | * | 74.013 |
| 38 | 10 | 15.171 | 0.261 | * | * | * | * | 131.085 |
| 11 | 10 | 8.254 | 0.221 | 65.887 | 2.128 | * | 22672.723 | 131.103 |
| 37 | 10 | 4.571 | 0.314 | * | * | * | 26257.369 | 152.658 |
| 36 | 10 | 20.406 | 1.089 | * | * | * | high | 83.669 |
| 35 | 10 | 28.520 | 1.326 | * | * | * | high | 167.314 |
| 160 | 48 | 0.089 | 0.000 | 12.945 | 21.037 | 6.860 | 5869.797 | 0.476 |
| 161 | 48 | 0.000 | 0.000 | 28.468 | 3.328 | 9.843 | 355.130 | 0.156 |

Part 1. Raw Metals in Solution (ppb).

| Ex | Cr | Mn | Fe | Co | Ni | Cu | Zn |
|---|---|---|---|---|---|---|---|
| No | 52 | 55 | 57 | 59 | 60 | 63 | 66 |
| 159 | 12.635 | 6.603 | * | 2.090 | 22.097 | 46.214 | 15.229 |
| 14 | * | 24.935 | * | 3.150 | 87.089 | 3.834 | 5.084 |
| 13 | 114.915 | 74.911 | * | 16.734 | 308.134 | 33.149 | 41.592 |
| 8 | 100.600 | 25.059 | * | 12.530 | 118.126 | 23.281 | 34.060 |
| 20 | 121.304 | 79.026 | * | 33.478 | 344.468 | 5.669 | 175.834 |
| 27 | * | 69.876 | * | 94.604 | 507.737 | 337.786 | 216.746 |
| 28 | * | 65.972 | * | 74.721 | 511.411 | 2.854 | 128.599 |
| 30 | * | 133.543 | * | 27.212 | 434.571 | 13.311 | 59.733 |
| 16 | * | 31.076 | * | 8.002 | 39.712 | 46.240 | 36.721 |
| 33 | 39.441 | 49.318 | * | 83.647 | 372.011 | 152.349 | 195.930 |
| 31 | * | 127.544 | * | 22.248 | 463.706 | 30.022 | 80.510 |
| 32 | * | 147.330 | * | 19.156 | 500.341 | 36.804 | 98.536 |
| 38 | * | 175.441 | * | 36.579 | 487.033 | 88.901 | 111.217 |
| 11 | 43.617 | 7.556 | * | 34.412 | 266.174 | 105.190 | 84.565 |
| 37 | 37.313 | 103.618 | * | 36.401 | 225.748 | 113.669 | 97.569 |
| 36 | * | 66.365 | * | 57.780 | 574.455 | 206.824 | 122.394 |
| 35 | * | 2.406 | * | 63.671 | 638.636 | 260.850 | 139.955 |
| 160 | 41.456 | 0.467 | 2412.940 | 0.041 | 0.219 | | |
| 161 | 2.865 | 0.000 | 2514.013 | | | | 3.479 |

Part 2 (ppb).

| Ex | Ga | As | Se | Rb | Y | Ag | Cd | Cs | Ba | La | Ce | Pr | Sc | Nd | Sm |
|---|---|---|---|---|---|---|---|---|---|---|---|---|---|---|---|
| No | 69 | 75 | 82 | 85 | 89 | 107 | 111 | 133 | 138 | 139 | 140 | 141 | 45 | 142 | 152 |
| 159 | 6.962 | 0.452 | 0.258 | 0.797 | 2.563 | 1.976 | 0.072 | 0.119 | 0.550 | 1.780 | 2.568 | 0.481 | 3.109 | 2.177 | 5.636 |
| 14 | 23.013 | 3.701 | 4.653 | 0.386 | 1.188 | 0.304 | 0.038 | 0.009 | 11.577 | 3.997 | 5.630 | 0.331 | 50.141 | 1.421 | 14.845 |
| 13 | 43.319 | 19.770 | 3.853 | 0.853 | 3.160 | 18.376 | 0.138 | 0.033 | 2.061 | 9.538 | 7.205 | 0.768 | 94.182 | 2.920 | 21.094 |
| 8 | 14.877 | 10.310 | 1.598 | 0.268 | 1.174 | 15.454 | 0.086 | 0.014 | 55.990 | 2.945 | 5.394 | 0.317 | 41.100 | 1.212 | 4.265 |
| 20 | 59.298 | 83.232 | 33.741 | 1.796 | 4.626 | 23.019 | 0.397 | 0.174 | 13.393 | 25.636 | 8.982 | 1.512 | 31.010 | 3.805 | 7.235 |
| 27 | 20.145 | 129.815 | 3.707 | 1.173 | 3.013 | 45.066 | 0.127 | 0.056 | 1.936 | 5.104 | 6.419 | 0.583 | 45.944 | 2.095 | 2.312 |
| 28 | 46.862 | 135.811 | 11.100 | 2.748 | 3.485 | 9.421 | 0.213 | 0.117 | 1.940 | 6.901 | 5.985 | 0.578 | 44.113 | 2.094 | 4.270 |
| 30 | 94.156 | 94.243 | 8.366 | 3.363 | 4.168 | 7.381 | 0.203 | 0.135 | 1.930 | 17.972 | 9.093 | 0.992 | 44.158 | 3.196 | 9.978 |
| 16 | 11.759 | 4.823 | 11.160 | 0.195 | 2.040 | 3.575 | 0.181 | 0.048 | 36.097 | 9.181 | 6.827 | 0.736 | 8.519 | 1.798 | 0.296 |
| 33 | 5.804 | 92.489 | 4.237 | 0.293 | 2.346 | 52.490 | 0.064 | 0.030 | 20.109 | 2.165 | 13.267 | 0.328 | 35.054 | 1.544 | 0.808 |
| 31 | 55.798 | 127.275 | 13.694 | 1.688 | 3.753 | 6.313 | 0.230 | 0.093 | 1.927 | 10.247 | 8.925 | 0.756 | 48.391 | 2.672 | 5.492 |
| 32 | 85.039 | 120.082 | 16.315 | 2.260 | 4.430 | 7.882 | 0.231 | 0.090 | 1.925 | 11.796 | 8.825 | 0.778 | 45.325 | 2.670 | 6.580 |
| 38 | 61.816 | 117.392 | 62.184 | 4.140 | 10.921 | 22.504 | 0.480 | 0.484 | 1.895 | 31.020 | 15.839 | 3.218 | 53.772 | 9.443 | 6.807 |
| 11 | 12.563 | 40.360 | 95.902 | 2.116 | 13.180 | 14.699 | 0.560 | 0.405 | 9.168 | 22.320 | 11.864 | 3.101 | 26.028 | 9.437 | 1.778 |
| 37 | 11.077 | 32.013 | 79.087 | 2.335 | 10.807 | 32.571 | 0.507 | 0.495 | 7.519 | 39.313 | 17.287 | 4.912 | 25.862 | 14.214 | 2.766 |
| 36 | 15.252 | 117.194 | 279.967 | 6.668 | 40.301 | 26.540 | 1.646 | 1.379 | 1.773 | 106.953 | 39.464 | 13.508 | 48.271 | 37.365 | 5.353 |
| 35 | 19.728 | 110.467 | 373.853 | 9.549 | 26.302 | 22.971 | 2.150 | 1.948 | 1.828 | 79.682 | 29.621 | 9.007 | 53.999 | 24.875 | 4.189 |
| 160 | 2.343 | 0.159 | −0.193 | 0.026 | 5.701 | 0.065 | −0.001 | 0.001 | 0.724 | 0.030 | 2.805 | 0.003 | 0.000 | 0.119 | 0.010 |
| 616 | 0.079 | 0.025 | −0.287 | 0.000 | 0.584 | −0.004 | −0.002 | 0.000 | 5.344 | 0.043 | 1.825 | 0.004 | 0.000 | 0.021 | 0.005 |

Part 3 (ppb).

| Ex | Eu | Gd | Tb | Dy | Ho | Er | Tm | Yb | Lu | Hg | Tl | Pb | Bi | U |
|---|---|---|---|---|---|---|---|---|---|---|---|---|---|---|
| No | 153 | 158 | 159 | 164 | 165 | 166 | 169 | 174 | 175 | 202 | 205 | 208 | 209 | 238 |
| 159 | 14.494 | 5.033 | 0.495 | 1.269 | 0.159 | 0.862 | 0.183 | 0.547 | 0.090 | 0.105 | 0.058 | 7.409 | 0.261 | 0.111 |
| 14 | 10.705 | 1.106 | 0.100 | 0.209 | 0.032 | 0.158 | 0.015 | 0.069 | 0.018 | | 0.045 | 3.979 | 0.066 | 0.049 |
| 13 | 14.534 | 1.673 | 0.152 | 0.391 | 0.054 | 0.252 | 0.021 | 0.119 | 0.025 | 0.531 | 0.184 | 8.718 | 0.107 | 0.126 |
| 8 | 2.817 | 0.631 | 0.063 | 0.167 | 0.026 | 0.101 | 0.010 | 0.059 | 0.011 | 0.677 | 0.070 | 5.748 | 0.078 | 0.056 |
| 20 | 5.269 | 0.473 | 0.079 | 0.414 | 0.070 | 0.199 | 0.027 | 0.146 | 0.034 | 2.031 | 0.232 | 13.103 | 0.309 | 1.809 |
| 27 | 106.535 | 0.393 | 0.065 | 0.250 | 0.044 | 0.113 | 0.194 | 0.061 | 0.010 | 0.022 | 0.149 | 24.970 | 0.107 | 0.297 |
| 28 | 154.889 | 0.349 | 0.061 | 0.241 | 0.044 | 0.105 | 0.261 | 0.052 | 0.010 | | 0.237 | 11.761 | 0.050 | 0.217 |
| 30 | 14.263 | 0.488 | 0.063 | 0.268 | 0.033 | 0.098 | 0.022 | 0.045 | 0.008 | | 0.440 | 4.821 | 0.062 | 0.109 |
| 16 | 0.000 | 0.273 | 0.059 | 0.290 | 0.068 | 0.204 | 0.031 | 0.166 | 0.034 | 4.097 | 0.031 | 8.610 | 0.139 | 1.908 |
| 33 | 1.174 | 0.558 | 0.066 | 0.266 | 0.054 | 0.141 | 0.017 | 0.081 | 0.014 | 0.426 | 0.024 | 39.413 | 0.060 | 0.481 |
| 31 | 55.062 | 0.485 | 0.061 | 0.253 | 0.043 | 0.111 | 0.111 | 0.056 | 0.012 | | 0.298 | 8.113 | 0.054 | 0.234 |
| 32 | 7.191 | 0.431 | 0.058 | 0.263 | 0.042 | 0.104 | 0.015 | 0.058 | 0.014 | | 0.452 | 8.036 | 0.079 | 0.204 |
| 38 | 3.936 | 1.300 | 0.208 | 0.870 | 0.159 | 0.466 | 0.053 | 0.282 | 0.057 | 0.271 | 0.302 | 18.738 | 0.353 | 3.106 |
| 11 | 0.643 | 1.574 | 0.299 | 1.352 | 0.305 | 0.938 | 0.119 | 0.694 | 0.143 | 3.763 | 0.067 | 19.854 | 0.592 | 7.431 |
| 37 | 1.227 | 1.802 | 0.309 | 1.275 | 0.258 | 0.743 | 0.089 | 0.473 | 0.091 | 2.454 | 0.088 | 24.403 | 0.520 | 6.824 |
| 36 | 1.834 | 5.209 | 0.981 | 4.255 | 0.916 | 2.734 | 0.355 | 2.089 | 0.422 | 7.670 | 0.245 | 41.112 | 1.576 | 30.336 |
| 35 | 1.550 | 3.485 | 0.634 | 2.704 | 0.570 | 1.736 | 0.237 | 1.361 | 0.291 | 1.619 | 0.464 | 48.103 | 2.162 | 40.195 |
| 160 | | 0.006 | 0.001 | 0.002 | 0.003 | 0.001 | 0.000 | 0.001 | 0.000 | 0.479 | 0.004 | 0.288 | 0.007 | 0.008 |
| 161 | | 0.003 | 0.001 | 0.005 | 0.001 | 0.003 | 0.000 | 0.001 | 0.000 | 0.247 | 0.002 | 0.045 | | |

### Example 9

### Source Dissolution and Swelling

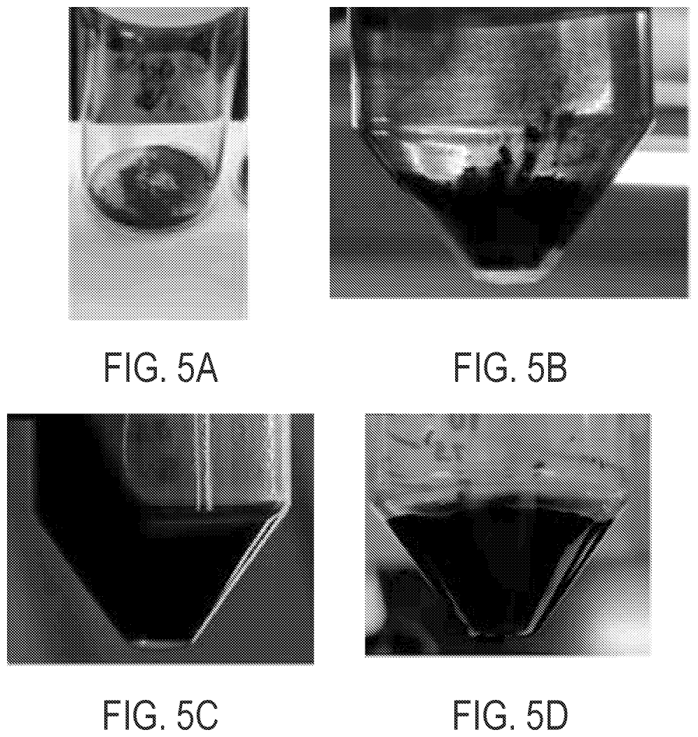

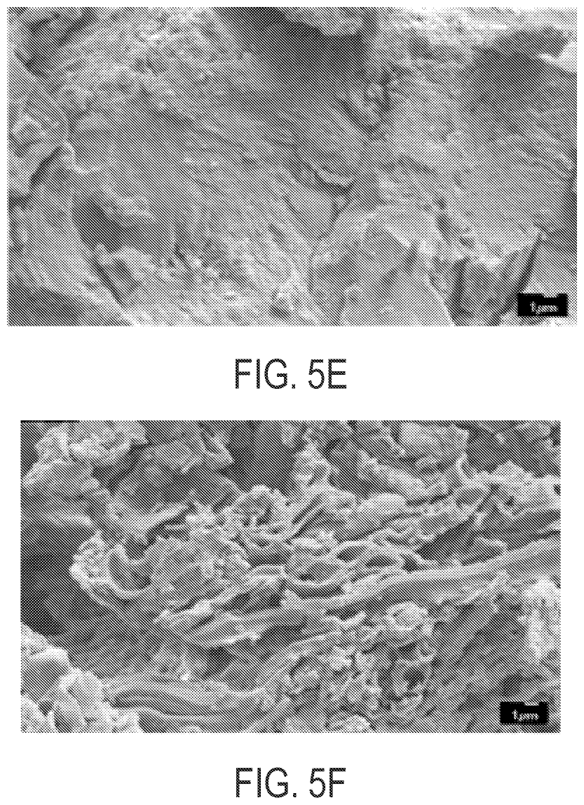

Dissolution and swelling were observed following CRC treatment with IL #1. Residue (solid extraction product) was isolated via centrifugation and washed several times to remove residual IL. Noticeable swelling occurred and was confirmed via scanning electron microscopy (SEM). This residue is a novel product of the extraction process. See FIGS. 5A-5F.

### Example 10

### Carbonaceous Materials Extracted From CRC/IL #1 Solutions After Residue Removal via Centrifugation

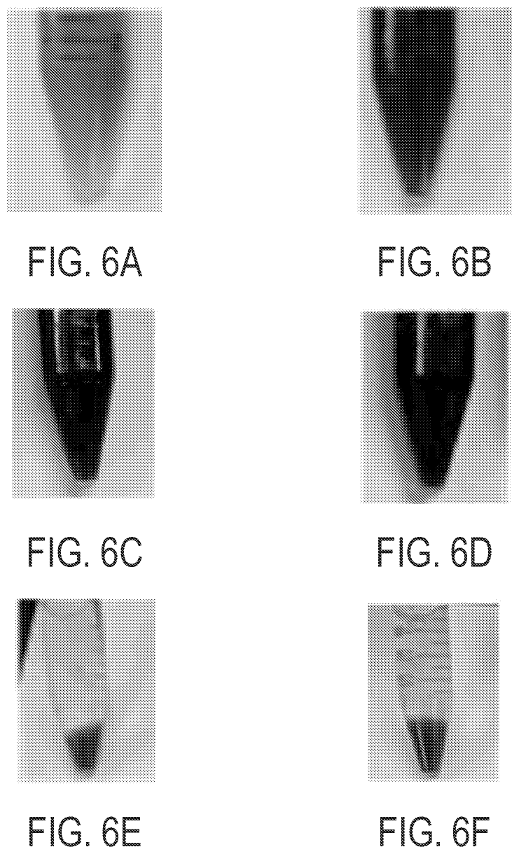

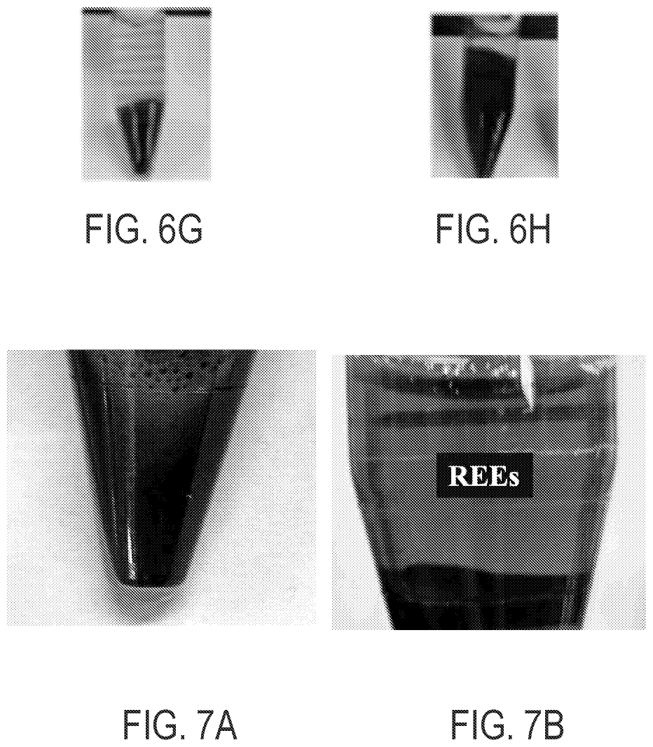

The addition of H₂O to the CRC/IL #1 solutions resulted in an extracted solid carbonaceous material and an extracted aqueous layer. Degree of carbonaceous material dissolution (and overall CRC dissolution) were observed upon the addition of H₂O. Microwave treatment resulted in the dissolution in minutes. Upon the addition of H₂O alone to the CRC/IL #1 solution, a precipitate formed, resulting in from 33% to 52% of REEs in solution and ˜50% in the precipitate, confirmed via ICP-MS. FA/IL #1 solution and H₂O resulted in a very small amount of solid grey precipitation and higher concentrations of REE in solution. See FIGS. 6A-6H.

TABLE 7
Percentage of REEs in aqueous phase after addition of H₂O to the
source/IL solutions compared to starting source/IL solution. (%).

| Ex | | | | | | | | | | | | | | | | |
|---|---|---|---|---|---|---|---|---|---|---|---|---|---|---|---|---|
| No | Y | La | Ce | Pr | Nd | Sm | Eu | Gd | Tb | Dy | Ho | Er | Tm | Yb | Lu | U |
| 39 | 14 | 14 | 13 | 10 | 11 | 58 | 1 | 16 | 10 | 20 | 14 | 14 | 1 | 17 | 26 | 14 |
| 40 | 19 | 25 | 22 | 18. | 20 | 79 | 1 | 24 | 23 | 28 | 29 | 18 | 2 | 39 | 33 | 15 |
| 41 | 14 | 15 | 11 | 7 | 9 | 123 | * | 16 | 13 | 12 | 11 | 8 | 5 | 6 | 8 | 1 |
| 42 | 35 | 27 | 22 | 24 | 26 | 82 | * | 31 | 42 | 39 | 54 | 51 | 30 | 74 | 81 | 24 |
| 43 | 33 | 30 | 26 | 28 | 32 | 85 | * | 33 | 46 | 52 | 56 | 55 | 5 | 59 | 65 | 23 |
| 50 | 28 | 24 | 26 | 27 | 28 | 85 | 87 | 33 | 41 | 53 | 54 | 48 | 54 | 54 | 55 | 47 |
| 44 | 37 | 36 | 28 | 36 | 38 | 97 | 58 | 45 | 63 | 64 | 76 | 73 | 64 | 87 | 76 | 38 |

### Example 11

### Acidification of IL Solution

Acidification of the CRC/IL #1 solutions with 1 M HNO₃ resulted in an aqueous REE-containing (˜100%) layer (verified via ICP-MS), extracted solid carbonaceous layer, and an extracted oil layer. These separate layers were new compositions and contained valuable materials for further processing. The acidification of the coal/IL or fly ash/IL solution resulted in several extraction products including an REE-enriched (99%) aqueous layer, a REE-free solid precipitate, and a carbonaceous-oil phase. See FIGS. 7A-7B.

### Example 12

### REE Extraction Into Source/IL Solution

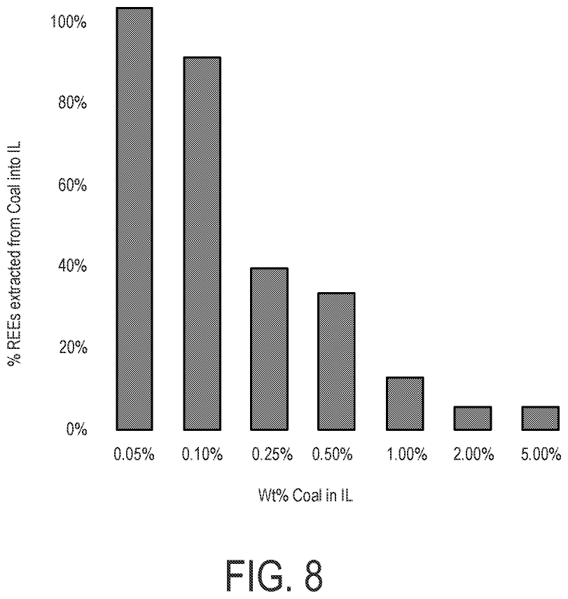

REE extraction into Source/IL solutions were measured via ICP-MS. This example describes CRC/IL #1 solutions following 2 min. of T3 with various 0.01 wt. % to 5 wt. %. 100% REE extraction was achieved at 0.01-0.05 wt. %, 92% REE extraction was achieved at 0.1 wt. %. T3 treatment of 0.01-0.1 wt. % CRC/IL #1 solutions was demonstrated to extract REEs with 92% to 100% efficiency in 2 minutes. See Table 8. See also FIG. 8.

TABLE 8

| | |
|---|---|
| | % REE extraction into |
| CRC:IL#1 wt. % | CRC/IL#1 Solution |

| | | |
|---|---|---|
| 0.01 | wt. % | 90-121% |
| 0.05 | wt. % | 86-104% |
| 0.1 | wt. % | 91.45% |
| 0.25 | wt. % | 39.61% |
| 0.5 | wt. % | 33.45% |
| 1 | wt. % | 12-38% |
| 2 | wt. % | 6.50% |
| 5 | wt. % | 3-18% |

### Example 13

### Extracting Additional Carbonaceous Materials, Metals, and REEs

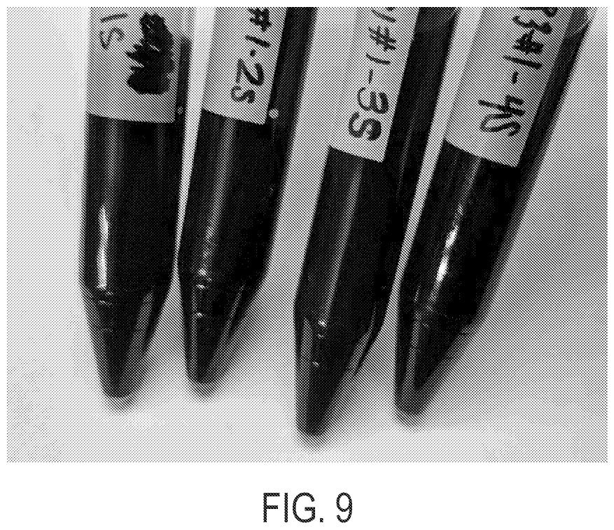

After initial treatment (T1, T2, T3) at 5 wt. % CRC/IL #1, the residue was removed via centrifugation, resuspended in fresh IL #1 of the same ratio (5 wt. %), and underwent additional, identical treatments. These treatments were able to extract additional carbonaceous materials, metals, and REEs, verified via ICP-MS. See FIG. 9.

### Example 14

### Differing Microwave Times

One minute up to ten minutes of T3 treatment was tested with comparable REE extraction. Using 0.01% to 5% CRC/IL#1, microwave times were varied from 1-10 minutes. No differences were observed in the REE extraction between 1 minute of T3 up to 10 minutes T3.

### Example 15

### Testing Particle Sizes to Determine Effect on Dissolution Parameters and REE Extraction

No significant differences in dissolution or REEs extraction were observed between various grind sizes (<45-250 μm and no sieve). Time after grinding was also examined due to the potential formation of an oxidation layer which might reduce the ability of the IL to extract REEs. No differences in REEs extraction were observed between immediately grinding the coal prior to treatment and IL treatment several days, weeks, or months after grinding. Coal particle size and time after grinding did not affect REEs extraction in coal. REE extraction was performed via ICP-MS.

### Example 16

### Differing Coal Moisture Content

Trials were performed with both wet coal (˜30% moisture content) and coal that had been dried overnight at 100° C. to remove moisture (H₂O content). Dry coal was verified by recording mass loss prior to treatment (˜27% mass loss in CRC, on average). There was no significant difference in the REE extraction from coal that was “wet” or pre-dried using T3 or T2. It was found that wet coal performed better than coal samples dried overnight at 100° C. with T1.

### Example 17

### Separation and Concentration REEs in Solution

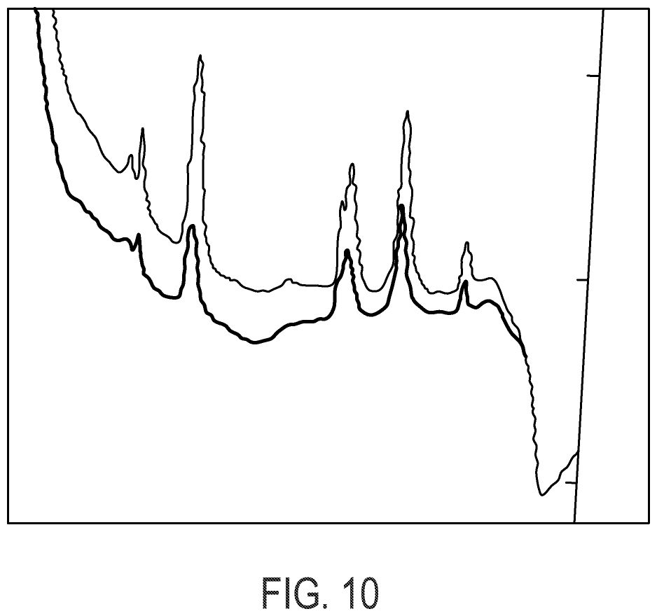

The separation/concentration of REEs in dissolved CRC/IL #1 solutions with REE-specific commercial resins was successfully demonstrated. Commercially available resins were tested in CRC/IL #1 solutions and CRC/IL #1 solutions doped with UV-vis responsive REEs (NdOAc or NdCl). REE separation was accomplished via (1) dilution of REE containing ILs with aqueous acid (due to resin specifications) followed by (2) exposure to REE-specific resins. 99% of REEs were removed from the CRC/IL #1 solutions by the resins (96% of REEs were removed from fly ash-IL solutions of the same loading, which are ˜10× higher than coal-IL solutions). This was confirmed using UV-visible spectroscopy and ICP-MS. See FIG. 10. REE content was measured in pre-exposed and post-resin exposed solutions as well as stripped resins to confirm the resin performance. Resins were able to isolate REEs and REEs were able to be recovered in aqueous solution. Ce-salts, Y-salts, and CRC/IL #1 solutions without additional REEs were also tested and resins were confirmed to perform as anticipated.

### Example 18

### Grinding of IL-Treated CRC Residues

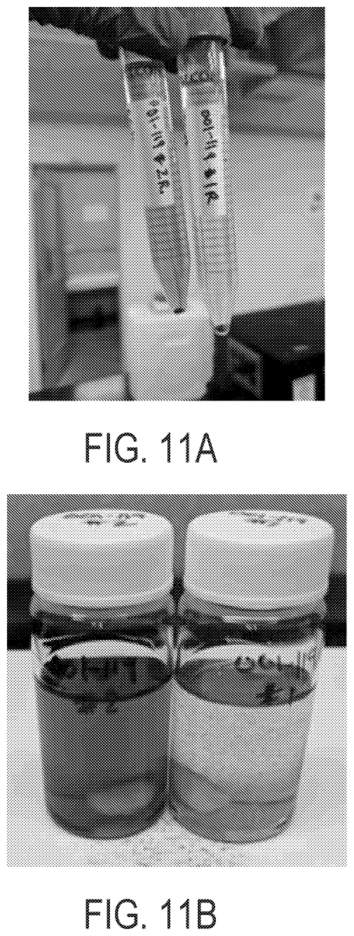

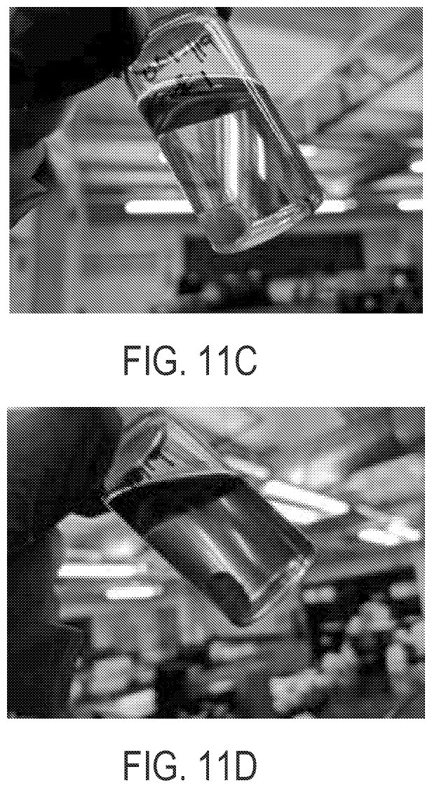

Additional grinding of IL-treated CRC residues resulted in improved overall dissolution and extraction. Swollen residue from initial 5% CRC/IL #1, 2 minute T3 samples were either ground (left) or not ground (right), re-suspended in IL #1, and treated again (T3 for 2 minutes). Grinding resulted in improved dissolution of the coal residue. After centrifugation it was evident that more particulate was dissolved in the ground sample. Additional ICP-MS results indicated REE extraction from both samples, with increased REE extraction in the ground sample. See FIGS. 11A-11D.

### Example 19

### Testing Alternate REE-Containing Source Materials

Alternate REE-containing source materials were tested and used in this process. PRB coal (CRC) was primarily used for the example given, herein, but other types of coal from PA (CLB-1) and AL (AL-1) were tested and it was found that similar extraction profiles of REEs at a consistent wt. % and treatment were achieved. Fly ash (FA) and landfill/bottom ash (BA) waste samples were tested, and REE-extraction was observed and verified via ICP-MS. Carbonatite (REE ore) samples were tested and exhibited extraction of REEs. Clinker samples (also referred to as slag, a waste product from coal fired power plants) demonstrated REE-extraction. REE-salts, oxides, and hydroxides were extracted in the ILs. T3 was found to be most effective for all sample systems. See Table 9.

TABLE 9

| | | % REE | | |
|---|---|---|---|---|
| Source | wt. % | extraction | Treatment | Time |
| FA | 0.03% | 11.35% | T3 | 2 min |
| FA | 0.10% | 12.13% | T3 | 2 min |
| FA | 5.00% | 3.00% | T3 | 2 min |
| CARB | 1.00% | 2.06% | T3 | 2 min |

### Example 20

### Performing Solvent Extractions

Solvent extractions were performed with the solutions (source/IL), residues, and additional steps in the process. Solvents used included acetone, toluene, water, acetic acid, ethyl acetate, nitric acid, hexane, hydrochloric acid, sodium hydroxide, other ILs, and combinations of each. Examples given in the table of experiments and ICP-MS data. (See Table 1.)

### Example 21

### Testing ILs and ILs Plus Additives for REE Extraction

Mixtures of ILs and ILs plus additives were tested for REE extraction in the first step (IL and Source). It was found that the addition of acetic acid diminished the REE-extraction, though still extracted some REEs. At 0.1 wt. % extraction lowered with the inclusion of acid from ˜92% with IL alone, to 44% with the addition of acetic acid. Acetic acid alone extracted ˜11% under the same conditions. IL #1 and PEG-300 increased the REE-extraction slightly after additional T1 followed by T3, but only moderately after T1, T2, or T3, alone. Examples given in the table of experiments and ICP-MS data. (See Table 1.)

### Example 22

### Compositions Generated in the Extraction Process

Coal and IL #1 were developed from the invention described. Coal was substituted for any REE-containing material. Additional compositions have been achieved via additional treatments, including solvent treatment, resin treatment, heating, microwave, and combinations of treatments. See FIG. 2.

### Example 23

### Scheme of Acetates

The range of reactions attempted between metal salts and [OAc]⁻ ILs is shown below. Reactions 1-6 were conducted by heating metal salt hydrates directly with one molar equivalent of the neat IL, and single crystals were picked directly out of the crude reaction mixtures and analyzed by SCXRD. The reaction mixtures of 1-4 contained non-crystalline solid, polycrystalline, and liquid phases in addition to the identifiable crystalline products, none of which were characterized. Reactions 5 and 6 gave homogeneous yellow powders composed of well-formed prismatic crystals. In reactions 7 and 8, solutions of metal salts were reacted with varying amounts of IL (from 1 to 8 molar equivalents) and evaporated over several days at 90° C. The reactions containing 5 equivalents of IL yielded the largest amount of crystalline solid, and crystals were isolated from these reactions for analysis by SCXRD. In reactions 9 and 10, the metal oxide powder was combined with [C₂mim][OAc] and an amphoteric molecule (2,5-diamino-1,2,4-triazole in reaction 9 and water in reaction 10). Total dissolution did not occur, but crystals grew spontaneously from reaction 9 after several days of heating and from reaction 10 after approximately 2 weeks of standing under ambient conditions.

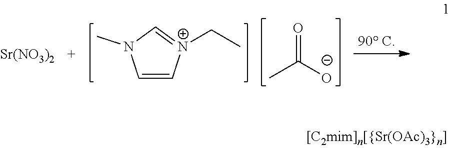

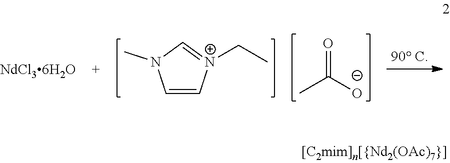

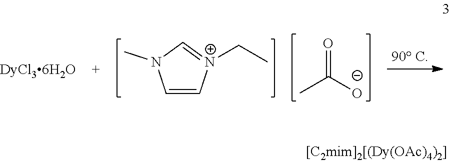

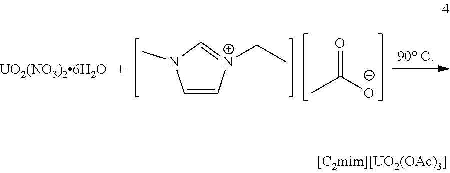

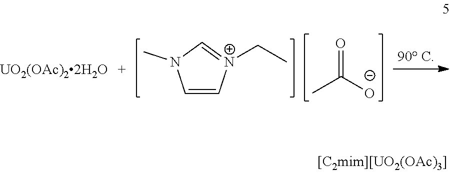

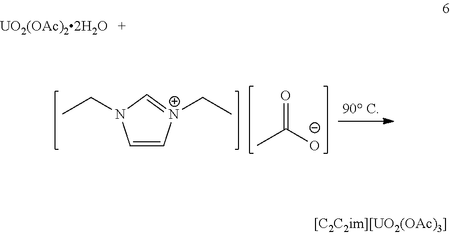

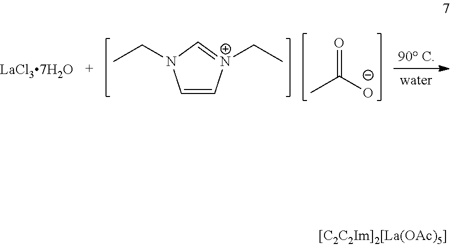

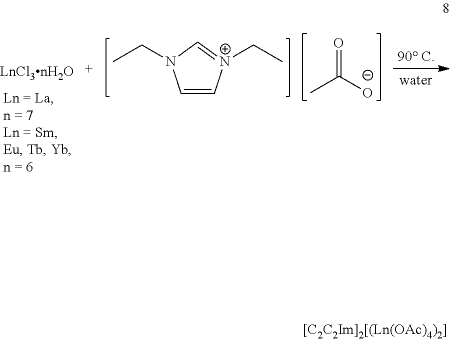

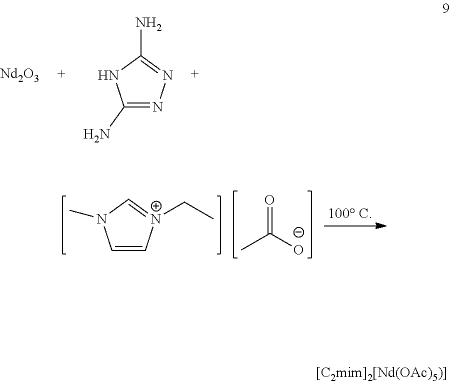

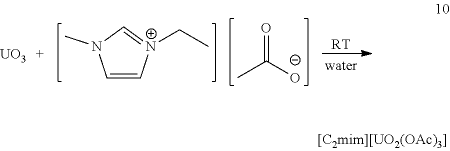

### Example 24

### Electrochemical Precipitation Technique

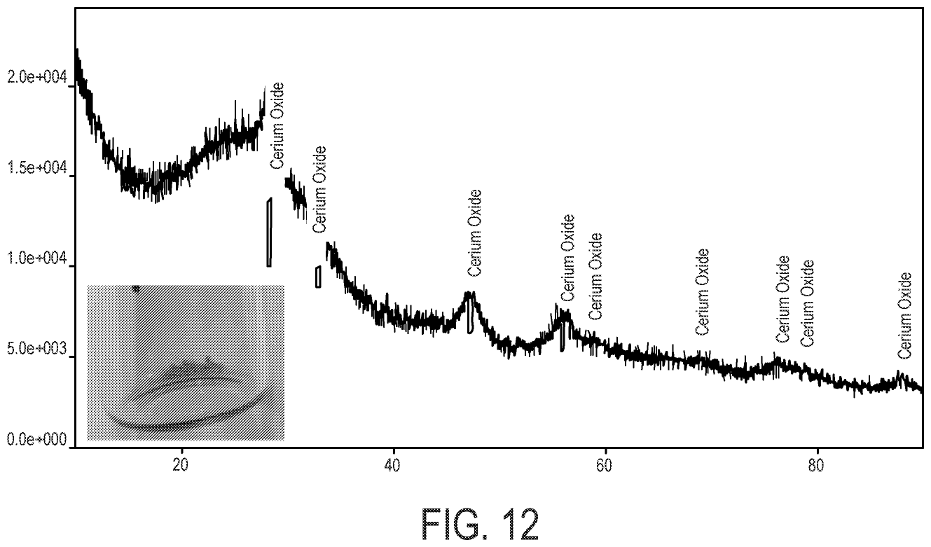

Cerium extracted from doped IL solution with electrochemical precipitation techniques. PXRD data confirmed the recovered REE-product. REEs were in hydroxide form after recovery. PXRD confirmed the electroprecipitation of several REE salts, including REE acetates from aqueous solution and from doped CRC/IL #1 solutions. See FIG. 12.

### Example 25

### Cerium, Neodymium and Yttrium Hydroxides

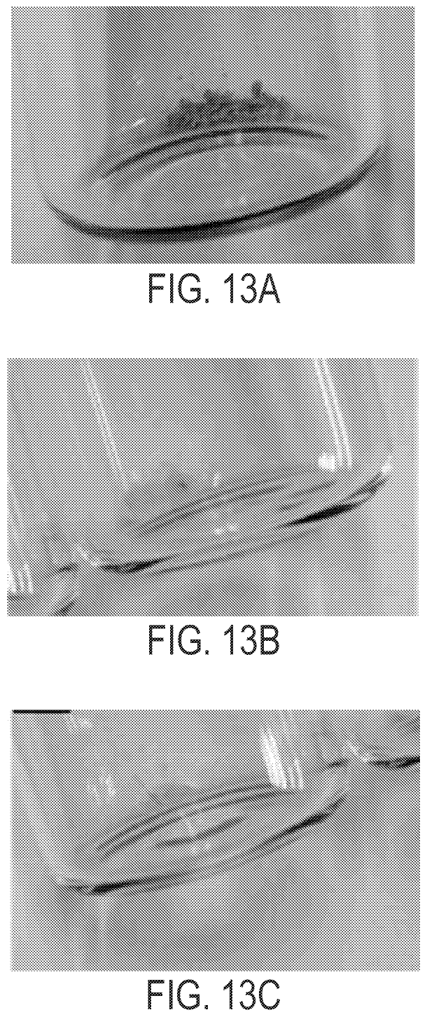

Cerium (A), Neodymium (B), and Yttrium (C) hydroxides were extracted from REE-OAc doped IL solutions using the developed electrochemical techniques. See FIGS. 13A-13C.

### Example 26

### Nd Electroprecipitation

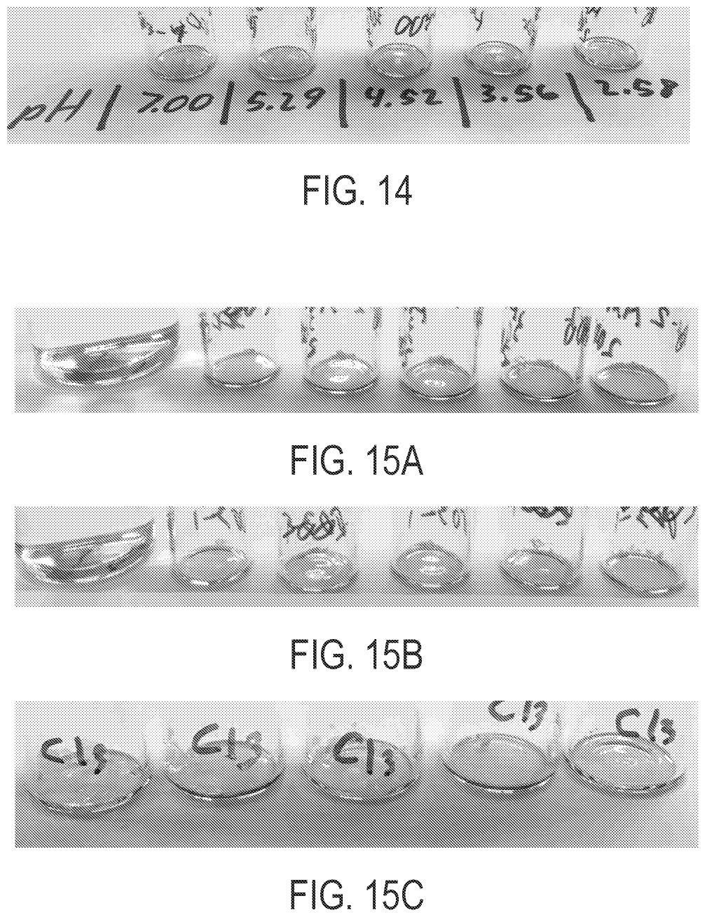

Nd electroprecipitation from simulated resin eluent at various pHs. Neutral pH was favorable to the electroprecipitation of REE hydroxides. See FIG. 14.

### Example 27

### Nd Electroprecipitation From Simulated Resin Eluent Varying Currents

Nd chloride salt, Nd acetate salt, or Y chloride salt were doped in aqueous simulated resin solution and electrodeposited. See FIGS. 15A-15C. Y acetate was also tested but is not shown.

Publications cited herein are hereby specifically incorporated by reference in their entireties and at least for the material for which they are cited.

It will be apparent to those skilled in the art that various modifications and variations can be made in the present disclosure without departing from the scope or spirit of the invention. Other embodiments of the disclosure will be apparent to those skilled in the art from consideration of the specification and practice of the methods disclosed herein. It is intended that the specification and examples be considered as exemplary only, with a true scope and spirit of the invention being indicated by the following claims.

1. A method of obtaining metals from a source, comprising contacting the source with an ionic liquid in the absence of acid, thereby extracting the metals from the source and providing an ionic liquid extraction composition; and recovering the metals from the ionic liquid extraction composition, wherein the source comprises coal, coal by-products, ore, tar, coal burning waste, mine tailings, industrial waste, municipal waste, or electronic waste.

2. The method of claim 1, wherein metals comprise alkaline metals rare earth metals, or any combination thereof.

3. (canceled)

4. The method of claim 1 wherein the source further comprises a biopolymer.

5. The method of claim 1, wherein the source is dried, ground, sieved, or any combination thereof.

6. (canceled)

7. The method of claim 65, wherein the source is ground to a particle size of less than 250 μm.

8.-10. (canceled)

11. The method of claim 1, wherein the ionic liquid is basic.

12. The method of claim 1, wherein the ionic liquid comprises a cation and a basic REE-coordinating anion.

13. The method of claim 1, wherein the ionic liquid comprises 1-ethyl-3-methylimidazolium acetate ([C₂mim][OAc]), choline acetate ([Cho][OAc]), octylammonium oleate, 1-ethyl-3-methylimidazolium hydrochloride ([C₂mim][HCl₂]), MimSO₃, [HN₂₂₂][Al₂Cl₇], 1-n-butyl-3-methylimidazolium sulfite (SO₃-C₄mim), [MimSO₃H][HSO₄], [MimSO₃H]Cl, ammonium oxalate, ([NH₄][C₂O₄]), non-stoichiometric mixtures of TEAL-based ionic liquids, or any combination thereof.

14. (canceled)

15. The method of claim 1, wherein the ionic liquid extraction composition comprises the source at a concentration of from 0.005% to 60% by weight of the ionic liquid extraction composition.

16.-19. (canceled)

20. The method of claim 1, wherein contacting the source with ionic liquid further comprises irradiating the ionic liquid and source with microwaves, ultrasound waves, or any combination thereof.

21. (canceled)

22. The method of claim 1, wherein contacting the source with the ionic liquid provides a swollen residue, undissolved residue, or any combination thereof.

23. (canceled)

24. The method of claim 1, wherein contacting the source with ionic liquid further comprises dissolving metal salts, metal hydroxides, metal oxides, or any combination thereof in the ionic liquid extraction composition.

25. The method of claim 1, wherein contacting the source with ionic liquid is done for from 1 second to 10 hours and/or at a temperature from 0° C. to 120° C.

26.-28. (canceled)

29. The method of claim 22, further comprising removing the swollen residue from the ionic liquid extraction composition, removing the undissolved residue from the ionic liquid extraction composition, or any combination thereof.

30. (canceled)

31. The method of claim 22, further comprising contacting the undissolved residue with the ionic liquid.

32. The method of claim 1, wherein recovering the metals from the ionic liquid extraction composition comprises adding base, ionic liquid, or any combination thereof, acidification of the ionic liquid extraction composition to precipitate the metals from the ionic liquid extraction composition, extraction of the metals from the ionic liquid extraction composition, adding sorbents to the ionic liquid extraction composition to adsorb the metals, or contacting the ionic liquid extraction composition to a resin.

33.-36. (canceled)

37. The method of claim 32, wherein performing resin separation further comprises treating the resin with acid.

38. The method of claim 1, wherein recovering the metals from the ionic liquid extraction composition comprises adding anti-solvent to the ionic liquid extraction composition to remove the ionic liquid.

39. The method of claim 1, wherein recovering the metals from the ionic liquid extraction composition comprises electroprecipitation to precipitate metals as insoluble hydroxides by increasing the concentration of OH⁻ at an electrode surface.

40. The method of claim 1, wherein recovering the metals from the ionic liquid extraction composition further comprises centrifuging the ionic liquid extraction composition.

41. (canceled)
